(19) United States
(12) Patent Application Publication
(10) Pub. No.: US 2004/0172558 A1
(43) Pub. Date: Sep. 2, 2004

(54) Method and system for access control

(76) Inventors: Terrance Callahan, Shelburne (CA); Steven Meyer, Richmond Hill (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 10/715,113

(22) Filed: Nov. 18, 2003

Related U.S. Application Data
(60) Provisional application No. 60/426,824, filed on Nov. 18, 2002.
(60) Provisional application No. 60/433,016, filed on Dec. 13, 2002.

(51) Int. Cl. H04L 9/00; H04L 9/32; G06F 11/30; G06F 12/14; G06F 15/16

(52) U.S. Cl. 713/201; 709/229

(57) ABSTRACT

In one aspect of the invention, embodiments of the invention can superimposed upon the existing framework of network which includes a number of nodes interconnected by the underlying communications network. In one embodiment, an access control node is interposed between each node and the remainder of the network. The access control node is adapted to transmit information about the node and the user attempting to access the node to a server used for maintaining security and audit information. This information may take the form of node identification data (thus identifying the node) and user identification data (to ensure that the user is associated with an active account and the user has entered the correct password thus authenticating the user). If the node is not recognised by the server, then no access to protected information (e.g., PHI) is allowed. If, however, the node is recognised, then access to PHI requires that the user also be authenticated. Assuming both conditions exist, aspects of the invention will determine (based on a repository of information about users) the data each user is entitled to access and the functionality of the node that is to be made available to the user. Aspects of the invention may place limitations on the functionality offered by the node to which the user should be granted access. That is, although a user may be attempting to access data from a node which has a set of functions (e.g., printing, storing data to a removable media, displaying video signals, etc.), aspects of the invention enable only a subset of these functions to be made available depending on the rights which have been granted to a user.

### FIELD OF THE INVENTION

The invention relates to the field of access control, and more specifically to a method and system for controlling access to health care systems to ensure patient privacy.

### BACKGROUND TO THE INVENTION

Over the years, especially in the past decade, significant efforts have been made to reduce the costs associated with the provision of health care services while maintaining efficiency and quality. As many would agree, the costs of health care systems in many countries, especially western, developed countries, has continued to increase at an astonishing rate One reason for the increase in costs has been a tremendous increase in the amount of information that is generated during the treatment of a patient. This information takes many forms. For example, providing health care services to an automobile accident victim may result in the creation of a huge amount of information. Basic information relating to their name, address and other personal information and their health insurance information may be entered into a computer system creating an electronic record. Paper forms completed by emergency services personnel at the scene of the accident may be created. X-rays and advanced imaging technologies may create film-based, tape-based and digital-based imaging records. The list goes on and on.

Part of the efforts to reduce costs has focused on the deployment of information technology to collect, collate and distribute electronic information where needed. Unfortunately, the development of these information technologies has been somewhat haphazard resulting in many different stores of information, many points of data entry and many points of data access. This, some have said, has reduced efficiency and increased costs. Moreover, all of the information may not be compatible with each information technology system deployed by one or more health care providers.

Running in parallel with the vast increase in the creation of health care information has been an increased awareness of the sensitivity and value of this information. Accordingly, efforts are ongoing in the protection of this information. This information or data protection generally falls under a few categories of efforts.

A first category of efforts relating the protection of information generally relates to ensuring that information is not lost. Accordingly, electronic data is regularly backed up by most modern information technology systems.

A second category of information protection relates to ensuring that the data is private. That is, only those needing access should be granted access. Moreover, access to a selected patient's information granted to a particular person should not be all encompassing. Rather, each person needing access should only be granted access to hose specific pieces of information to that selected patient needed for the particular person To perform their task or job. For example, a physician might be granted access to all health-related information for each person that the physician is treating but not all of the information relating to each of those patients. For instance, the physician may be prevented from accessing data for his/her patients relating to their health insurance or other accounting information. In contrast to the physician, certain accounting personnel may need to have access to some information for all patients. In this instance, the accounting personnel may be required to have access to each patient's accounting information but not any information relating to a patient's diagnostic and test results, for example.

A third category of information protection relates generally to security. That is, measures are needed to be in place to ensure that unauthorised access to information does not occur. Historically, these security efforts have been fairly limited. For example, a health care centre would provide each employee and contractor with a user name and password that would be required to access any electronic system.

Unfortunately, the efforts to date in providing information protection have been less than adequate. Moreover, the US federal government, like many other similar efforts by other governments around the world, has enacted the Health Insurance Portability and Accountability Act (HIPAA) in an effort to, inter alia, force health care providers and those handling patient information (e.g., health care centre employees, contractors, insurance companies, etc.) to satisfy at least minimum levels of health care related information protection. The HIPAA requires certain levels of security and privacy for all protected health information (PHI).

Unfortunately, resulting from the many varied forms of PHI (electronic and otherwise), the varied types of electronic devices that are used to create, store and access PHI (e.g., MRI scanners, CT scanners, automated test equipment, image retrieval computers, general purpose computers, etc.) and other factors, the ability to provide the desired (and now, due to the HIPAA, requisite) level of PHI security and privacy is typically inadequate.

Accordingly, some manner is required to address, at least in part, some of the shortcomings described above. The Integrated Health Initiative (IHE), a joint initiative between Radiological Society of North America (RSNA) and Health Level 7 (HL7) organisations has provided the Basic Security Integration Profile that establishes security measures, which provide patient information confidentiality, data integrity and user accountability (see www.rsna.org/ihe)

### SUMMARY OF THE INVENTION

Advantageously, aspects of the invention address some of the shortcomings described above. In one aspect of the invention, embodiments of the invention can be superimposed upon the existing network system, which includes a number of nodes interconnected by the underlying communications network. In one embodiment, an access control node is interposed between each node and the remainder of the network. The access control node is adapted to transmit information about the node and the user attempting to access the node to a server used for maintaining security and audit information. This information may take the form of node identification data (thus identifying the node) and user identification and password data (thus ensuring that the user is associated with an active account and the user has entered the correct password ensuring that the user has been authenticated). If the node is not recognised by the server, then no access to protected information (e.g., PHI) is allowed. If, however, the node is recognised, then access to PHI requires that the user also be authenticated. Assuming both conditions exist, aspects of the invention will determine (based on a repository of information about users) the data each user is entitled to access and the functionality of the node that is to be made available to the user.

Aspects of the invention may place limitations on the functionality offered by the node to which the user should be granted access. That is, although a user may be attempting to access data from a node which has a set of functions (e.g., printing, storing data to a removable media, displaying video signals, etc.), aspects of the invention enable only a subset of these functions to be made available depending on the rights which have been granted to a user.

In other aspects of the invention, messages that are being transmitted to or from the node to which a user has access will be monitored. These messages may be intercepted to determine whether the user, based on his/her access tights, should be receiving the messages which are being transmitted to the node or, alternatively, whether the data being transmitted by the user should reach its intended destination, also based on the user's access rights. Additionally or alternatively, aspects of the invention will capture from these intercepted messages information about the activities that involve the user. From this captured information, a detailed audit log can be created for future reference.

In another aspect of the invention there is provided a device that operates to selectively control a node associated with the device. This selective control may include providing electrical power to only portions of the associated node or enabling video (or other data stream) signals (analog or digital) to be passed to the associated node. The selective control may result from the co-operation between the device and a server that operates to determine a user's permissions to data and functionality.

In one aspect of the invention there is provided a method for providing access to data stored in a repository forming part of a network, said access being requested from a node also forming part of said network, said method comprising: receiving at an access control node user identification, user password and node identification data, said access control node interposed between said node and said repository; said access control node transmitting over said network said user identification and node identification requesting authentication for said access request; said access control node receiving control signals responsive to said authentication request; and responsive to said received control signals, selectively providing access to a subset of the functionality provided by said node.

In one aspect of the invention there is provided a method for providing access to data stored in a repository forming part of a network, said access being requested from a node forming part of said network, said method comprising: receiving user identification and node identification data from an access control node associated with said node; and transmitting control signals to said access control node, said control signals indicating limitations on the type of functionality to be provided to the user by said node, said user associated with said user identification.

In one aspect of the invention there is provided a device for providing control of a node, said node forming part of a network, said device comprising: an input for receiving user identification, user password and node identification data, said device interposed between said node and the remainder of said network; an output adapted to transmit over said network said user identification and node identification and data requesting authentication of the user identification and node identification and, responsive thereto, receive control signals responsive to said authentication request; and a switching device for selectively providing access to a subset of the functionality provided by said node.

In one aspect of the invention there is provided a computer readable media storing data and instructions, said data and instructions when executed by a general purpose computer adapt said computer to provide access to data stored in a repository forming part of a network, said access being requested from a node forming part of said network, said data and instructions adapting said general purpose computer to: receive data requesting authentication of the user identification and node identification data from an access control node associated with said node; and transmit control signals to said access control node, said control signals indicating limitations on the type of functionality to be provided to the user by said node, said user associated with said user identification.

In one aspect of the invention there is provided a method for generating audit logs for a network, said network comprising a plurality of nodes interconnected by way of a communications network, said method comprising: upon initial access by any user of a plurality of users, generating a login event record from user identification data received from an access control point from a plurality access control points, each of said plurality of access control points associated with one of said plurality of nodes; intercepting all messages transmitted to or from each of said plurality of nodes; and storing an audit log event in a repository for each activity identified in said intercepted messages.

In one aspect of the invention there is provided a method for providing access to data for a plurality of users, said to data stored on a network, said network comprising a plurality of nodes, each of said plurality nodes associated with an access control node, each of said access control nodes interposed between its associated node and the network, said method comprising: defining a plurality of roles to which users will associated; for each role defined, identifying the data for which access is to be granted and the type of functionality at each of said plurality of nodes that is to be made available to a user associated with a role; and associating each of said plurality of users with at least one of said defined roles.

### BRIEF DESCRIPTION OF THE DRAWINGS

Embodiments of the invention may best be understood by referring to the following description and accompanying drawings. In the description and drawings, like numerals refer to like structures and/or processes. In the drawings:

FIG. 1 is a block diagram illustrating audit response modules in accordance with an embodiment of the invention;

FIG. 2 is a block diagram illustrating the components forming the universal compliance module, a client side application, in accordance with an embodiment of the invention;

FIG. 3 is a block diagram illustrating directory caching in accordance with an embodiment of the invention;

FIG. 4 is a block diagram illustrating an exemplary access control node for implementing an embodiment of the invention;

FIG. 5 is a printed circuit board layout diagram illustrating a VGA switch in accordance with an embodiment of the invention;

FIG. 6, which comprises FIGS. 6(a), 6(b) and 6(c), is an exemplary bill of materials for the VGA switch of FIG. 5 in accordance with an embodiment of the invention;

FIG. 7, which comprises FIGS. 7(a), 7(b), 7(c) and 7(d), is a schematic diagram for the VGA switch of FIG. 5 in accordance with an embodiment of the invention;

FIGS. 8, 9(a)-9(d), and 13 are wiring diagrams illustrating an alternate switch in accordance with an embodiment of the invention;

FIG. 10 is a line diagram illustrating card reader timing in accordance with an embodiment of the invention;

FIG. 11 is a flow chart illustrating directory caching logic in accordance with an embodiment of the invention; and,

FIG. 12 is an exemplary listing of a XML log event in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practised without these specific details. In other instances, well-known structures and/or processes have not been described or shown in detail in order not to obscure the invention. In the description and drawings, like numerals refer to like structures and/or processes.

An embodiment of the present invention will be described under the following headings:

1. Introduction

2. Definitions

3. Product Description

3.1 Product Concept

4. Modules

4.1 Security Repository (SR)

4.1.1 Archive Module

4.1.2 Reporting Module

4.1.3 Status & Alarm Module

4.2 Universal Compliance Module (UCM)

4.2.1 Universal Compliance Module Application

4.2.2 User Authenticator Module

4.2.3 Card Authenticator Module

4.2.4 Logging API Module

4.2.5 Network Gateway Module

4.2.6 User Directory Caching Module

4.2.7 Switcher Control Module

4.3 Support Modules

4.3.1 User Directory

5. HIPAA Compliance

6. Detailed Design Description

6.1 Security Repository (SR)

6.1.1 Archive Module

6.1.2 Reporting Module

6.1.3 Status & Alarm Module

6.2 Universal Compliance Module (UCM)

6.2.1 User Authenticator Module

6.2.2 Card Reader Module

6.2.3 Legging API Module

6.2.4 Network Gateway Module

6.2.5 Directory Caching Module

6.2.6 Switcher Control Module

6.2.7 Fail-Safe Operation

6.3 Support Modules

6.3.1 User Directory

6.3.2 Information Required from the Directory

7. Summary

1. Introduction

The invention or embodiments thereof may be used to satisfy some of the requirements of the Health Insurance Portability & Accountability Act of 1996. Although preferred embodiments of the invention are described herein, it will be understood by those skilled in the art that variations may be made thereto without departing from the spirit of the invention. Further, even though the invention is described to addressing requirements related to the HIPAA, it will be understood by those skilled in the art that the invention is applicable to other information management systems.

The preferred embodiment described herein provides, amongst many other advantages, information security and privacy of information accessible through a computer system. Moreover, detailed audit logs detailing any access and/or attempted access to the information (e.g., PHI) are created and/or accessed in order to comply with the required security and privacy controls of HIPAA.

In overview of the exemplary embodiment of the invention, a collection of devices which can either display, create, delete or otherwise access PHI (hereinafter these devices are referred to herein as “nodes”) form a domain. This domain may include any type of node regardless of its geographical locality. For example, while most nodes may be physically present in a health care centre (e.g., a hospital campus, a health care business park, etc.), many of the nodes may be physically present at remote locations. These remote locations may be, for example, the office of physician that remotely connects to the health care centre's data repositories, a laboratory providing specialised diagnostic testing for patients of the health care centre, an office of an insurance provider, an office of a government regulatory agency requiring audit information or the like. As will be appreciated by those of ordinary skill in the art, the types of remote locations are quite numerable. It must be recalled that the method of connecting these various nodes may include conventional Information Technology (IT) networks (e.g., local area networks (LANs), wide area networks (WANs), metro area networks (MANs) and the like) but may also include other forms of communication (e.g., television or satellite communications and the like). Moreover, persons of ordinary skill will understand that the nodes may include not only IT type devices (e.g., electronic imaging devices that connect to a LAN/WAN, general purpose computers, dumb terminals, and the like) but also include many analog devices (e.g., televisions, video-cassette recorders, film processing systems, etc.).

To provide for security and privacy of PHI, aspects of the invention described herein embody the requirements of the IHE Basic Security Integration Profile (SEC) in an access control node (i.e., a conventional general purpose computer which has been adapted, as described in greater detail below, to enable control of PHI available to a user based on the permission which has been granted to the user). The access control node is installed between any node and the other portions of the domain. That is, for each node, there is an associated access control node

Once each node in a domain has been secured through the introduction of embodiments of the various aspects of the present invention, the domain can then be said to be secure.

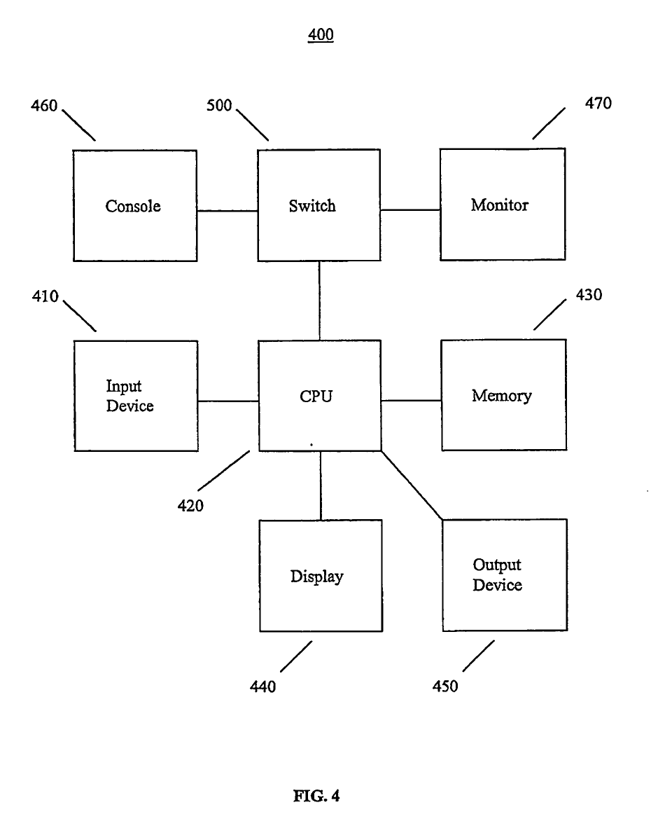

In satisfaction of aspects of the IHE SEC, the access control node 400 (FIG. 4) provides, inter alia, three main functions: (1) authentication of a user or operator trying to access (e.g., review, delete, view, update, create, distribute, etc.) PHI; (2) authentication of the node from which the attempt to access PHI is being made; and (3) the generation and transmission of audit events relating to the node associated with the access control node. Related to these functions, the access control node may, in some embodiments, also operate To either provide or deny electrical power to the associated node or portions thereof. Additionally, the access control node (also referred to as the HIPAAT gateway), based on the access granted to a user, may either permit or deny the transmission of various I/O data streams (e.g., video, audio, etc.), whether analog or digital, to or from the node. It is to be noted that a selected node may include several input/output (I/O) devices each of which may be authenticated and access granted or denied independently of each other by the access control node. The access control node is functionally driven, in the exemplary embodiment, by software referred to herein as the Universal Compliance Module

In an example operation, an operator desires to review a particular patient's PHI. In this exemplary operation the operator is a radiology technician requesting to review a recent MRI scan taken of the patient. The request is being made directly through the MRI scanning device—the node 460. In this case, the MRI scanner/node includes several different I/O components, each of which provides various types of potential access to PHI. For example, the MRI scanner is connected to a general-purpose computer, an external analog monitor, a printer and removable media storage device. Prior to the installation of the system described and claimed herein, the MRI scanner was directly connected to the computer network of the health centre in which it is housed. In the exemplary embodiment an access control node embodying aspects of the device is interposed between the MRI scanner and the health centre's network.

In the exemplary operation, the radiology technician may be presented with login screen (i.e., a screen to enter a Unique username and password combination) by the access control node 400 once the user has been provisionally authenticated The access control node 400 provides authentication through a user identification token (e.g., a magnetic card and an associated reader 410). As will be appreciated other forms of user authentication could be employed. For example, some biometrics device such as a fingerprint scanner, retinal scanner or the like (e.g, an RFID radio transmission) could be employed.

Initially, the technician swipes his/her magnetic card through the magnetic card reader 410 in order for the login screen to be presented and for the requisite login data to be provided (through an input device such as, for example, a keyboard or key pad 410). The access control node 400 queries a user directory server on the network to determine the user information associated with the magnetic card. This information may also be cached locally for improved efficiency, as described in greater detail later in this document. Once the card has been correctly read by the card reader 410 and identified (i.e., the data stored on the card corresponds to an active user of the system), the technician/user is presented with a logon screen on the display unit by the access control node 400. In the exemplary embodiment, the technician/user is prevented from entering a login name that differs from the login name associated with the data stored by the magnetic card. Accordingly, the technician is only able to input a PIN (personal identification number—e.g., a password that, in the exemplary embodiment, may contain only numeric characters). Moreover, the technician may only enter the PIN required to gain access within a configurable and limited time after the magnetic card has been read by the card reader 410/access control node 400 and has been provisionally authenticated. It is expected that the time limit will, in many configurations, be set to 30 seconds. Accordingly, if the proper PIN is not entered within this 30 second time limit, the user will have to re-swipe their magnetic card in order to be provided with access the logon screen. Failure to enter the proper PIN within this time limit will, in the exemplary embodiment, result in the logon screen be withdrawn from display and any input being rejected by the access control node.

The access control node 400 then uses the combination of the PIN, the data provided by the magnetic card and the user directory server to determine whether the technician/user is an authentic user of the system (i.e., the magnetic card is active, the data is correct and the PIN entered by the user corresponds to the records maintained by the user directory server corresponding to the card swiped by the technician/reader). Also, upon input by the user/technician of login data (the PIN in the exemplary embodiment), the access control node transmits this event to the application 202, another aspect of the present invention HIPAAT application 202 provides access control node 400 with access to centralised services available via the network. In the exemplary embodiment access control node 400 accesses a centralised user directory and a security repository 102.

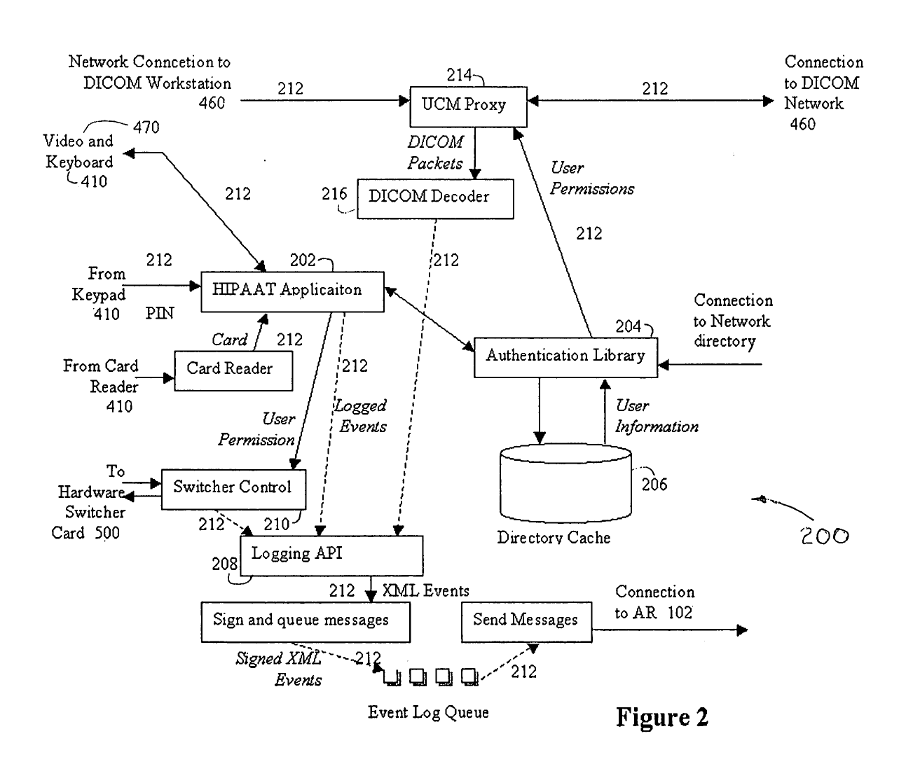

The centralised user directory stores details about users (including, for example, active user accounts, the associated passwords and the access rights of those users to PHI and node functionality) and the nodes (including, for example, those nodes which are entitled to be connected to the network). Since a node may be disconnected from the network (especially if the node is designed to be physically mobile), access control node 400 may, be adapted, to maintain a copy of the user directory locally. In this manner, access to the functions provided by a mobile node may be provided while still ensuring the necessary security and protection of PHI stored on or generated by the mobile node. FIG. 2 includes an illustration of a local copy of user directory 206.

Security repository 102 provides centralised storage of events for which an audit record has been created. Accordingly, security repository 102 may be queried so as to generate any necessary audit report (assuming the user requesting such a report has the necessary access rights to do so).

In addition to providing user authentication (through the magnetic card and correct PIN input), the universal compliance module 200 also determines whether the node 460 from which the user/technician has requested access is also authenticated. Node authentication is performed by appending a digital signature to every message sent to the HIPAAT application 202. The first message that the node sends to the HIPAAT application 202 when it starts up will be checked by the HIPAAT application 202 using a predefined, stored key to determine the node's authenticity. Thereafter all messages received from the node 460 will be checked to determine that they do, in fact, all originate from the same node. Assuming that the node and user have each been properly authenticated, the HIPAAT application 202 determines the degree to which the user has been granted permission to access the various types of PHI that are available for access from that particular node and the PHI available to the user/technician.

For example, and as noted above, the MRI scanner includes multiple input and output (I/O) devices. Further, the HIPAAT application 202 will also determine, based on the data associated with the user requiring authentication and the node 460 from which access is being requested, those I/O devices for which the user will be provided access. Accordingly, assume in this case that the technician has been granted permission to review any patient's MRI scan that has been previously created or create (i.e., store) new MRI scans. However, the technician has not been granted permission to print or store scans on a removable media In this instance, the HEPAAT application 202, having previously authenticated the user/technician and the node (the MRI scanner), will use data or control signals to the control aspects of control node 400 corresponding to the user's/technician's degree of permission. Based on the data or control signals about the technician's degree of permission, the access control node 400 will, through both command signals and control of power (via switcher card 500—also referred to herein as the VGA card), disable both the removable media storage device and the printer. The general purpose computer (i.e., the display, the input devices, etc.) and the analog monitor of the MRI scanner will be accessible and usable by the technician.

In addition to the foregoing, the access control node 400 and the HIPAAT application 202 work co-operatively to generate audit logs of activity at a node 460 associated with the access control node. The audit logs will include data relating to both denials and grants of access. For example, if the magnetic card entered by a user had been previously revoked, no access to PHI will be granted. Despite a denial of access, the HIPAAT application 202, through its co-operation with the access control node, will still collect audit information.

To better understand these and other aspects of the preferred embodiment of the invention described above, greater and more specific details are provided below.

2. Definitions

SR—Security Repository

UCM—Universal Compliance Module

HIPAA—Health Insurance Portability and Accountability Act of 1996

3. Product Description

3.1 Product Concept

A wide range of products will be required to fulfil the tremendous need created by the new HIPAA regulations. One embodiment of the invention provides a complete “system”. Although a stand-alone system, it consists of a host of offerings that is available and can be implemented in various software modules and some hardware combinations including:

1. Software libraries that can be used with various operating systems (e.g., Windows, Linux, and Unix platforms). This will allow a vendor's engineering department to have control of development (at a fee), but not need to develop a solution from scratch.

2. Complete software modules that can easily be integrated into a purchaser's device. The vendor will define the supported platforms.

3. Hardware/software systems that provide “ready-to-go” solutions for the purchaser. These will be turn-key solutions require little or no development or configuration on the part of the purchaser.

Many hospitals and their suppliers will require unique solutions, making the task of developing a single solution more complex. Because many hospitals already have “access control” systems in place for physical entry to facilities, they may not be open to a new and different “access control” device for their computer systems. Further, any new and/or different access control devices would, preferably, integrate with their existing systems.

In accordance with one broad aspect of the invention there is provided a comprehensive system capable of satisfying various aspects of HIPAA compliance. The system is adapted to connect to and communicate with hardware from a variety of suppliers (e.g., GE, Siemens, Hitachi, Fuji, etc.) simply, provide access controls (and other security issues), handle privacy issues, and create an Security Repository showing that the various activities were logged.

4. Modules

The following describes the modules included in the preferred embodiment.

4.1 Security Repository (SR)

In the exemplary embodiment, the SR 102 (also referred to as the Archive Repository) is a stand-alone server comprising a database including a web-based interface. The SR 102 server receives logging messages from the devices on the network and decodes and stores these logging event details in the database. As noted above, a separate web interface allows an authorised user to query the database and produce reports.

4.1.1 Archive Module

The Archive module 104 archives the logging events and saves the data into the SR database.

4.1.2 Reporting Module

The Reporting Module 106 produces the query reports needed. (Note: User authentication is needed to produce reports.)

4.1.3 Status & Alarm Module

The Status and Alarm Module 108 tracks the status of all the registered access control nodes (described below), and generates a log and/or alarm if any unit fails to respond or is otherwise disabled.

4.2 Universal Compliance Module (UCM)

As noted above, the UCM 200 forms the software which controls the functionality of the access control node 400(FIG. 4). The UCM 200 controls the flow of information between a Digital Imaging and Communications in Medicine Standards (DICOM) workstation and the DICOM network and also controls access to the DICOM workstation. The embodiment of the invention described herein also supports workstations and equipment complying with additional and alternate standards including HL7 (i.e. Hospital Level Seven) standards.

As will be appreciated, the UCM 200 has, in the exemplary embodiment, been designed in a modular fashion. Consequently, many of the functions performed by UCM 200 (and, thus, by access control node 400) are embodied in a smaller, more easily managed, software components or modules.

4.2.1 Universal Compliance Module Application

The UCM Application 202 (FIG. 2) (also referred to as the HIPAAT application) is the master program that controls the behaviour of and resides on, the access control node, specifically stopping and starting components, displaying messages to the screen and logging users in and out. Other components provide gateway communications, user directory access, data conversion etc.

4.2.2 User Authenticator Module

The User Authenticator Module 204 communicates with the User directory 206 to verify the username/magnetic card ID and password/PIN. In the exemplary embodiment an authenticator API is provided to allow different types of authenticator modules to be later developed. This module will provide an authentication override mechanism, so that emergency clinical actions can be taken, even when authentication is not possible or not successful.

4.2.3 Card Authenticator Module

The Card Authenticator Module operates to query a user's card, token or other identification device that is employed (e.g., retinal scanner, fingerprint scanner, etc.). In the exemplary embodiment only the magnetic card readers are supported.

4.2.4 Logging API Module

The Logging API module 208 provides a software library that accepts the logged events and queues and sends them to the SR 102.

4.2.5 Network Gateway Module

The Network Gateway Module (or UCM Proxy) 210 intercepts DICOM network messages and analyses and captures audit information therefrom. This module also relays DICOM network messages received from or for the node for which a user has been properly authenticated. That is, the Network Gateway Module 214 operates to intercept DICOM message destined for and transmitted by a node. These intercepted messages are only relayed to their intended destination (e.g, another part of the network for DICOM messages originated from the node 460 or the node itself for DICOM network messages addressed to the node) only once that a node and user have been properly authenticated by the UCM Application 202.

4.2.6 User Directory Caching Module

The User Directory Caching Module keeps a synchronized copy of user information required by a node for use when the system goes mobile and is disconnected from the network

4.2.7 Switcher Control Module

The Switcher Control Module 210 provides the digital outputs needed to control the switcher hardware according to role-based permissions.

4.3 Support Modules

The following modules are provided by the exemplary embodiment to support the development, testing and demonstration of the HIPAAT system.

4.3.1 User Directory

The User Directory is provided if a user directory is not available by the information systems employed by the facility deploying embodiments of the invention (e.g., a hospital, health care campus, etc.). That is, a user directory (which includes a list of all users which have been granted various degrees of access to PHI, user passwords/PINs, the PHI for which a user has been granted access and the type of access so granted—i.e., review, create, delete, store, distribute, print, etc.) may already be in some information systems into which embodiments of aspects of the invention are being deployed. In this case, adding another user directory may be redundant. If such a user directory does not already exists, then one is provided. Such a user directory is preferably provided by a centralised storage facility so that this information accessibly by any of the nodes and the associated access control nodes 400.

5. HIPAA Compliance

The following table describes security and privacy regulations as outlined by HIPAA.

| Functional | | |
|---|---|---|
| Requirement | HIPAA Requirement | Embodiment of the Invention |
| Audit controls | Required under HIPAA “Administrative and Technical | The UCM Application 202 stamps each |
| | Security Services to Guard Data Integrity, Confidentiality | activity with user ID, date and time in |
| | and Availability”. Security and Electronic Signature | addition to other extended audit control |
| | Standards, Proposed Rule, Aug. 12, 1998, pages 43250, | features of the database. |
| | 43269 and 43270. | |
| Data Backup | Required under HIPAA “Administrative and Technical | Utilises the standard database backup |
| Mechanisms | Security Services to Guard Data Integrity, Confidentiality | feature. It is the responsibility of the |
| | and Availability”. Security and Electronic Signature | medical practice to ensure regular backups |
| | Standards, Proposed Rule, Aug. 12, 1998, page 43251, | are carried out as well as ensuring off site |
| | which describes a “data backup plan”. | storage of such backups. |
| Unique User IDs | “Individual authentication of users” is required under | The Authentication Library 204 in |
| | HIPAA “Technical Security Services to Guard Data | conjunction with the Directory Server |
| | Integrity, Confidentiality and Availability”. Security and | permits only unique user IDs. Unique user |
| | Electronic Signature Standards, Proposed Rule, Aug. 12, | IDs are required to support adequate audit |
| | 1998, page 43250. | controls. |
| Data Security | Data security is required under HIPAA “Technical | Will secure critical information and the |
| | Security Services to Guard Data Integrity, Confidentiality | encryption of communicated data across |
| | and Availability”. Security and Electronic Signature | the network. |
| | Standards, Proposed Rule, Aug. 12, 1998, page 43254. | |
| Consent | Informed, voluntary patient consent is required for certain | |
| Mechanisms | PHI uses under HIPAA. Standards for Privacy of | |
| | Individually Identifiable Health Information, Proposed | |
| | Rule, Nov. 3, 1999, page 59940. | |
| Mechanisms to | It is unclear from HIPAA if identification of individual | The Security Repository 102 stamps each |
| link or identify | users is required at the data level as is the case with | activity with unique user id, date and time, |
| individual users | paper-based health information. Under the “Technical | which is then stored in the Security |
| with specific | Security Services to Guard Data Integrity, Confidentiality | Repository. This function is available at a |
| entries in the | and Availability”, “entity authentication” requires unique | record level. |
| electronic health | user identification along with a list of other implementation | |
| record. | features. Security and Electronic Signature Standards, | |
| | Proposed Rule, Aug. 12, 1998, page 43254. | |
| Mechanisms to | In so far as “data authentication” is a required technical | |
| allow individual | security service under HIPAA, it may be inferred that such | |
| users to alter | mechanisms are necessary under the Act. Security and | |
| entries in the | Electronic Signature Standards, Proposed Rule, Aug. 12, | |
| electronic health | 1998, page 43254. | |
| record without | | |
| deleting previous | | |
| (clinical) entries | | |
| Digital signatures | Digital signatures can be inferred and may fall under the | |
| | “user-based” access control requirement. HIPAA | |
| | “Technical Security Services to Guard Data Integrity, | |
| | Confidentiality, and Availability” under the Security and | |
| | Electronic Signature Standards, Proposed Rule, Aug. 12, | |
| | 1998, page 43254. | |
| Automatic log-off | Automatic log-offs are required under HIPAA. See | The UCM 200, supports automatic screen |
| | “Technical Security Services to Guard Data Integrity, | locking, network access control and |
| | Confidentiality, and Availability” under the Security and | automatic log-off of users. |
| | Electronic Signature Standards, Proposed Rule, Aug. 12, | |
| | 1998, page 43254. | |
| Mechanisms to | Under HIPAA, patients will have access rights not only to | Patients can request reports of the Audit |
| facilitate | their personal health information but also to organisational | Log through operation of the Archive |
| individual patient | privacy and security policies. (Standards for Privacy of | Module 104 and Security Repository 102 |
| access to personal | Individually Identifiable Health Information, Proposed | pertaining to their records. HIPAAT is |
| health | Rule, Nov. 3, 1999). | also able to provide electronic copies of |
| information | | documents and record whether the patient |
| | | has acknowledged them or not. By way of |
| | | example, the Notice of Privacy Practises |

6. Detailed Design Description

This design description addresses the class A and class B requirements of the HIPAA that are supported by the embodiment of the invention described herein.

6.1 Security Repository (SR)

In one embodiment of the invention, the only limit on the number of access control nodes 400 or gateways that can be connected to an SR is the size of the SR's hard drive. A practical limit may be defined for performance testing of simultaneous transfer, as well as database size for audit events.

In one embodiment of the invention, the Security Repository employs standard Linux server components;

Computer Operating System

SQL database

Web server

SSL encryption library

Web scripting

A Digital Certificate module (capable of creating, storing and managing digital certificates) is installed in the SR to support the secure transfer of information between the UCM units/servers and the SR as well as for secure web-based (HTTPS) access.

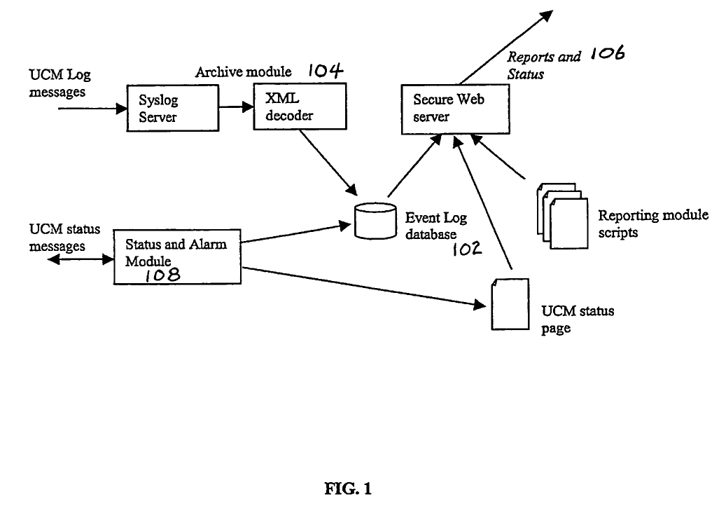

Referring to FIG. 1, a block diagram illustrating audit response modules in accordance with an embodiment of the invention.

6.1.1 Archive Module

The following describes the archive module 104 in one embodiment of the invention.

The SR 102 software uses a database such that advanced queries can be performed on the audit data. The database may be a conventional relational database supporting the Structured Query Language (SQL). For example, the IBM DB2 Universal Database, PostgreSQL, Oracle Database or Microsoft SQLServer, could be employed in various embodiments of the invention described herein

The amount of audit entries on the SR 102 could easily be in excess of millions as large numbers of personnel access various types PHI from the nodes of a health care centre. In some embodiments the SR 102 has been adapted to provide for the easy location of specific information. In these embodiments, the search capabilities of the database employed to provide some of the functionality of the SR are made available for users to search for particular information. Tis search functionality is preferably provided through a easy-to-use Graphical User Interface (GUI) for those users performing ad hoc queries or for novice users. A command line interface or compiled SQL queries may be preferred for those queries that are often repeated or for more advanced users of the search functionality.

For example, two exemplary searches are provided:

1. Searches a “selected patient” file and provides a chronological summary of all trigger events for any chosen period

2. Search by a “selected User” and provides a chronological summary of files accessed for any chosen period.

The SR 102 software provides a warning when the hard drive storing the audit database has reached 75% capacity. In some embodiments, this threshold is configurable and may provide for the storing of the database across multiple physical or logical drives.

In the preferred embodiment, the SR 102 software provides a mechanism to archive older events to free up space in the database. That is, older audit information may be moved from a hard drive to a cheaper storage alternative (e.g., tape storage, DVD, etc.).

The mechanism may store older events to an archive. In an alternative embodiment, an option may be provided for an archive that will be used for long-term audit trail backup. An on-board DVD in the SR 102 may be provided to facilitate this long-term backup.

The SR 102 software additionally is adapted to provide users with the opportunity to view archived events from long-term storage (e.g., tape or DVD storage media) without restoring these events to the quicker, network accessible hard drive storage. This functionality allows a user to review audit events to assess whether these events should be transferred back to the hard drive from long term storage.

The SR 102 software also provide a user with the ability to merge an archived database with a current database. This functionality of the SR 102 software leverages the ability of known relational databases to access repositories of data across different media types (e.g., hard drives and tape storage).

The database used by the SR 102 software provides support data integrity tools to minimise the chance of data corruption/loss. The relational databases identified above provide this functionality to various degrees.

The database used by the SR 102 software has been selected to sustain sudden loss of power without data corruption/loss.

In some embodiments of the invention, the information described below is captured for every log record. This information will be recorded in the database employed by the SR 102 software.

| | |
|---|---|
| Unique Activity identifier | Each activity is provided with a globally unique identifier given it |
| | by the device creating the event. The globally unique will |
| | eliminate ambiguity and provide for distributed cross-referencing |
| | of events. In the embodiment the globally unique identifier is |
| | automatically generated programmatically for each audit event (or |
| | activity) that is to be stored in the database |
| Link Activity identifier | If an activity is directly related to a previous activity, then this |
| | field will provide the backward reference. (Obviously, there can |
| | never be such a thing as a forward reference). The link activity |
| | identifier may be, for example, the inclusion of the unique activity |
| | identifier for the previous activity in a link activity identifier |
| | column in a relational database table. |
| Date and time of the activity | Every activity must be ordered according to the system-wide |
| | clock. Although it may not be possible to perfectly synchronise all |
| | devices, the timestamp, in the preferred embodiment, is always |
| | greater than that of any other network message already received. |
| Validity time/duration | Used to assist clean-up of the database. |
| Source identifier/signature | This is the identifier of the machine used to produce the activity |
| | log entry. In one embodiment, the MAC address of the node that |
| | is the source of the activity is used. |
| Owner identifier | This is the identifier of the owner of the information reported by |
| | the activity log. (e.g. the patient). |
| Audit data | Activity log details - activity dependent as specified by IHE. |
| (from XML) | |
| Authorised user | This is the identifier of the user generating the information. If |
| identifier/signature | possible, it will also contain a digital signature from the process |
| | that validated the user, providing some guarantee that the |
| | validation process was, in fact, carried out. Accordingly, in the |
| | embodiment described herein, a unique identifier of the user is |
| | maintained by the Authentication Library in conjunction with the |
| | HIPAAT Server which permit only unique user IDs. A digital |
| | signature generated by the Authentication Library indicating that |
| | the user has been properly recognised and authenticated is also |
| | preferably stored. |
| Log digest/signature | This acts as a secure checksum on the data, allowing the recipient |
| | to authenticate the source of the data and to verify that the data has |
| | not been corrupted. |

6.1.2 Reporting Module

The following describes the reporting module 106 in some embodiments of the invention. In the embodiment described herein a web-based report access and generation function is provided by the Reporting Module 106. The web-based reports are only accessible to authenticated Audit users. That is, users will have to be logged in and have capabilities (i.e., permissions) to access the logs. Given that web browsers have become ubiquitous on numerous types of devices (e.g., personal computers, personal digital assistants, wireless devices such as mobile telephones, etc.), a web-based report access and generation functionality enables a very large number of nodes to gain access to this important data (assuming, of course, that both the node and the user accessing the node have been properly authenticated).

The web-based reports provided by the Reporting Module 106 of the system described herein generally fall into four main categories:

1. Per-patient reports: This report shows all of the events for a particular patient.

2. Per-user report: This report shows all of the activities for a particular technician or physician (i.e., for a particular user).

3. Per date/time period: This report shows events for the period selected by a user (e.g., a specific date, a specific time or a range of dates and/or times).

4. Per audit event: This report shows all of the patients that have been affected by a specific audit event. For example, a report could be generated that will identify each patient that has had their PHI access for a particular type of audit event (e.g., have had their accounting information accessed).

In addition to the above categories or filters (singly or in combination), there is provided sorting by date/time, by patient and by user. This functionality is provided in the exemplary embodiment through access to pre-written queries that are performed by the Reporting Module. The results of these queries are then formatted by the database into a web page format. An authenticated user can then use the generated report. As will be appreciated, the reporting module will also allow the authenticated user to view the status of the access control nodes 400 remotely.

The SR 102 software uses a database such that advanced queries can be performed on the audit data. In the exemplary embodiment, the SR 102 software employs a conventional relational database that provides the advanced query functionality of the audit data stored in a repository by the SR 102 software. As will be appreciated, the amount of audit entries on the SR could easily be in excess of millions of records. Accordingly, a relational database which provides a mechanism the for the easy location of specific information is highly desirable.

Two exemplary searches are:

1. Searches a “selected patient” file and provides a chronological summary of all trigger events for any chosen period

2. Search by a “selected User” and provides a chronological summary of files accessed for any chosen period.

6.1.3 Status & Alarm Module

The following describes the status & alarm module 108 in some embodiments (including the preferred embodiment) of the invention:

The Security Repository (SR) 102 will register the status of the access control nodes 400 through network communication, and periodically verify his status. If the verification fails (i.e., a selected access control node does not provide a response to a status inquiry transmitted by the SR), an alarm will be issued by the SR 102 by way of an on-screen message. Data corresponding to the status of the access control nodes 400 in a system will be available to the Reporting Module 106 for displaying to remote web users.

In one embodiment of the invention, there is provided integration with simple network management protocol (SNMP).

The SR 102 logs the inability to communicate with the access control node 400. Failure to communicate with an access control node 400 results in an alarm or other warning indicative of the failure of an UCM. The status and alarm module 108 allows a system administrator to be informed of the status for all access control nodes 400.

In the exemplary embodiment, the status and alarm module 108 software runs in the background on an administrator's machine. Moreover, the status and alarm module 108 provides to an administrator a visual warning that one or more access control nodes 400 is unresponsive to status inquiries. In the exemplary embodiment, the status inquiries to each of the access control nodes 400 is provided through the SR 102 “ping”ing each access control node 400 periodically. The software should be configurable to display a “popup” any time an access control nodes was not protecting its intended device. Since the access control nodes are fail-safe th y are designed to fail in a way that permits clinical activity rather than prevents it. Preventing activity may be more intuitive but is generally not acceptable in a medical environment.

In the exemplary embodiment, the SR 102 operates to prevent a user to remotely logon or into to an access control node 400 if that user has already remotely logged into a different access control node. Note that if the access control node is in portable mode, there will be no way of knowing, and therefore, the login should be allowed. ‘Portable’ is used to describe equipment that is carried or wheeled around, typically to a patient's bedside or perhaps shared between departments. In many cases the networks are disconnected to do this and reconnected when the equipment is returned.

6.2 Universal Compliance Module (UCM)

The UCM unit includes a mechanism to prevent viruses from affecting software performance. In the preferred embodiment, this virus prevention mechanism may include a conventional enterprise level virus detection and removal software.

Referring to FIG. 2, a block diagram other aspects of the access control node 400/gateway modules in accordance with an embodiment of the invention are illustrated.

6.2.1 User Authenticator Module

The user authenticator module 204 in the embodiment of the invention described herein provides for the authentication of a user desiring access to PHI from a secure node and, if authenticated, the access rights (i.e., permissions) of the user to the requested PHI.

User-based access to the a workstation 460 (e.g., a DICOM workstation) and the network 212 will be governed by:

Successful authentication of the user (e.g., an active magnetic card together with the correct password or PIN). A user directory will be used to authenticate the user credentials.

User access rights, which will be obtained from the directory server 206. The user access rights determines not only the information to which the user has been granted access/permission but also limitations on what the user may do with that information.

For example, a user may be granted to access to an MRI scan of a selected patient (i.e., the user has been granted access or permission to this data). Additionally, the user may be have limitations on the operations that can be performed on the data to which access has been granted. For example, the user may be prohibited from making a copy of the data (in a tangible or electronic format—i.e., no printing, no saving of an electronic copy, no transmission).

Retrieval of Audit information will be controlled according to the user's directory entry. Such access will be granted independently of DICOM workstation access.

Role-based access is a feature that allows the clinical organisation to implement policies that control the usage of PHI. The product supports the following roles:

Auditor: able to access the audit logs

Discloser: able to print, forward and export PHI

User: able to create and view PHI.

While three (3) such roles are described above, persons of ordinary skill in the art will appreciate that other roles could be additionally or alternatively created depending upon the environment and needs of user into which an embodiment of the invention has been deployed.

Each user, to facilitate ease of administration of a system embodying This aspect of the invention, will be assigned to one or more roles. Each role will have certain permissions and limitations placed on any PHI that are to be accessed. A user will then be assigned to one or more of these roles. For example, it may be desirable to create a “Physician” role and grant to users that have been assigned to this role the right to access any medical related data in the PHI for any patient in the system Additionally, the Physician role would have the ability to create, print, forward and export PHI but not to delete any PHI. Accordingly, rather than re-creating permissions and limitations for a new physician being granted access to PHI, the new physician can be assigned an account that has been granted the role of Physician.

The UCM software (i.e., application) allows role-based access options. The defined roles in the exemplary embodiment are as follows:

User: Defines the ability to create, modify, delete (locally) and import PHI. A User may also send PHI to pre-determined recipients, such as an image archives.

Discloser: All the capabilities of the User, but in addition a Discloser has the ability to send PHI to a wide range of recipients and to export PHI in a variety of different formats. (e.g. create a CDROM of the PHI or send the PHI to a network printer)

Auditor: This role provides all the capabilities of the Discloser and in addition permits access to reports on PHI usage and on system status.

The automatic logout time for the UCM is configurable. After a time equal to the automatic logout time has elapsed since a user has last performed an activity (e.g., accessed some PHI data, created PHI data, etc.), the user is automatically logged out by the HIPAA gateway. This will result in the access control node interposed between the node and the UCM preventing any further access to new data or operations to be performed on data that has been previously accessed and was in the process of being processed (i.e., operated on) by the user at the node.

In the exemplary embodiment the automatic logout time is configurable in minutes to 10, 15, 20, 30 (default), 60 minutes, or off (i.e., this functionality is disabled and a user will not be automatically logged out due to the lapsing of time).

Any network activity from the device that the access control node 400 is protecting (i.e., the UCM software is communication with a node through the physical connectivity provided by the access control node) resets the timer that is monitoring activity for automatic timeout. Consequently, whenever there is network activity between the node and the UCM, the timer used for automatic logging out of a user will be reset to zero. The timer will then commence marking time until either more network activity is detected (at which time the timer will again be reset to zero) or the automatic logout time threshold will be set (if it has not been disabled).

When the UCM software detects that the automatic timeout limit has been reached, the UCM software logs the user out.

When the UCM software detects that the automatic timeout limit has been reached, the UCM software informs the user that the maximum inactivity time has be reached, and that they must login again.

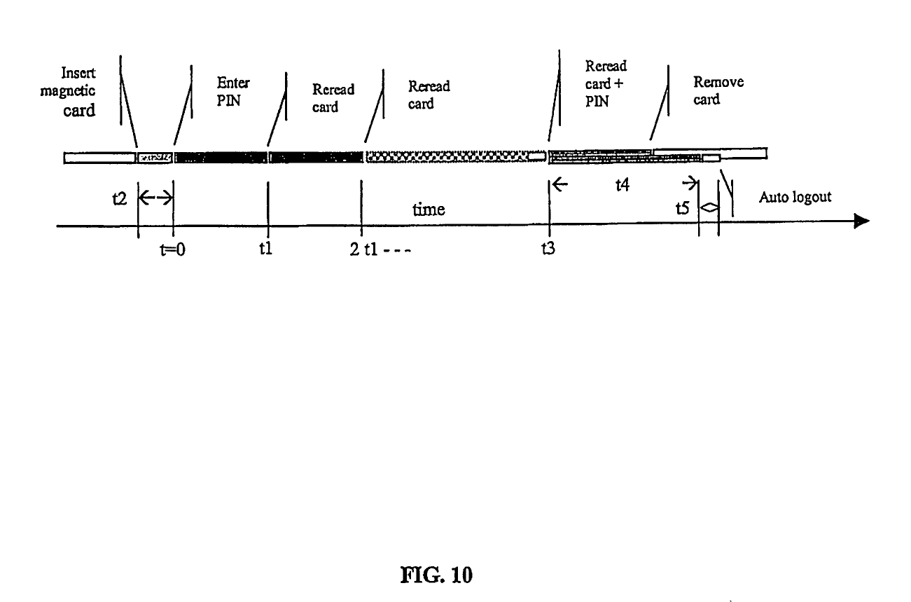

Referring to FIG. 10, a line diagram illustrating card reader timing in accordance with an embodiment of the invention is illustrated. As persons of ordinary skill in the art will appreciate, each of the time limits described below can be configured to satisfy the needs of the users of the embodiment of the present invention.

| Time | | | |
|---|---|---|---|
| parameter | Description | Typical setting | |
| t1 | Card validation interval - card must be present in reader | 10-30 | minutes |
| | or card must be inserted/swiped again. | | |
| t2 | Maximum time between inserting the card and entering | 30 | seconds |
| | the PIN. Failure to enter a PIN within a time “t2” will | | |
| | result in the user having to insert/swipe their card again. | | |
| t3 | PIN validation interval - card must be present in reader or | 1-3 | hours |
| | card must be inserted/swiped again and PIN must be | | |
| | entered. If this feature is configured as operational, a user | | |
| | must enter their card and PIN after the configured time, | | |
| | “t3” has elapsed regardless of the amount of time which | | |
| | has elapsed since the last event/activity. | | |
| t4 | Auto logout time - time since last activity (keyboard, | 5-20 | minutes |
| | mouse event, network activity). If configured to be | | |
| | operational this feature will automatically logout any user | | |
| | if there has been no activity in the past “t4” time period. | | |

| | | |
|---|---|---|
| t5 | Grace period - user is warned that the session will be | 30 seconds-3 |
| | ending. This feature works co-operatively with the auto | minutes |
| | logout feature. | |

In one embodiment of the invention, The SR integrates “Role Based Access” software to allow user access only to the authorised level.

6.2.2 Card Reader Module

The following describes the card reader module in some embodiments of the invention In one embodiment of the invention, the reader will require magnetic card insertion and entry of a PIN on the keyboard or other input device.

The access control node 400 includes the ability to provide user authentication by using a magnetic ID Card in conjunction with a PIN or other password type. A card proximity device may also be used as opposed to card swiping. After entering both card and PIN successfully, only card (no PIN) is required for re-login following a normal logout (i.e. pushbutton or card proximity). An automatic logout occurs when inactivity (no network traffic) exceeds the allowable time (configurable in minutes to 10, 15, 20, 30 (default), 60, unless this feature has been disabled). After an automatic logout, the user must enter card. The card-only login time is limited to a configurable time of 8, 12 (default), or 24 hours (or off), after which time the card and PIN combination is required.

As persons of ordinary skill in the art will appreciate other forms of identification could be employed. For example, RFID tags or fingerprint or retinal scanners could also be employed.

6.2.3 Logging API Module

The following describes the logging API module 208 included in the preferred embodiment of the invention.

The logging API module 208 will present a programmatic interface based on the parameters required for each log event. This module will format the logging messages according to the XML schema defined in the IHE specification, and transmitted to the SR 102. This module supports encryption, content certification (signing), queuing, transport and tracing/debugging. A private encryption key will also be installed for use by this module in order to sign the log messages.

When offline, the UCM software queues all audit trigger events, such that they can be transferred to the SR when a reconnection is made.

6.2.4 Network Gateway Module

The following describes the network gateway module 204 the preferred embodiment of the invention.

Audit events are detected by monitoring of DICOM TCP/IP messages by the network gateway module 204. In the exemplary embodiment, the exception to this will be the analog print triggers, which will be detected by the Switcher Control module.

The UCM software prevents other devices on the network 212 from having access to the node it is protecting. Additionally, the UCM software prevents the node to which its associated access control node is connected from having access to the rest of the network. However, the UCM software does not affect the data that passes through it in any way.

In the exemplary embodiment, the UCM software is further adapted to SSL-encrypt all non-SSL-encrypted PHI for electronic transfer and accept SSL encrypted or unencrypted DICOM data.

6.2.5 Directory Caching Module

The following describes the directory caching module 206 in the embodiments of the invention described herein. Caching of the directory is needed in order to support “mobile operation” of the units. Mobile operation of the access control node involves the operation of the access control node during a period when the node and its associated access control node have been disconnected from network. Such a disconnection may be intentional or unintentional.

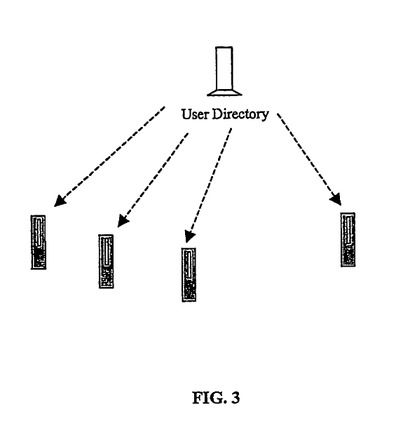

Referring to FIG. 3, a block diagram illustrating directory caching in accordance with an embodiment of the invention.

The UCM software is adapted to allow user authentication when in portable mode (not connected to the network—intentionally or unintentionally). Prior to mobile operation, the UCM software will download a list of all possible users. The downloading, in the preferred embodiment, is preformed whenever the access control node connects to the central authentication database residing on the SR 102. The access control node 400, through operation of the directory caching module, will update its list of users periodically (e.g., daily, upon start-up, etc.). In general, there is no need to push the User List to all access control nodes 400 when a new user added.

The Directory Caching module will update the local cache at predefined intervals (e.g. daily, upon start-up, etc.).

Configuration parameters for the UCM software will be stored in a hospital directory server or a central directory server provided if the hospital does not have such a server.

6.2.6 Switcher Control Module

The switcher control module 210 in the preferred embodiment of the invention provides the interface to the Switcher Cards (described below). The switcher control module 210 includes outputs for The power modules, the video relays, the analog printer trigger signals, and emergency override control.

The UCM software is adapted to interrupt the flow of a video signal to the device to which it is connected. The UCM software interrupts the flow of the video signal through control of Switcher Card 500 described in greater detail below.

The UCM software is adapted to display video that it generates back onto the screen of the device to which it is connected. For example, the UCM software may be connected to diagnostic device (e.g., an MRI scanner, a general purpose computer, etc.) that includes a video display (e.g., a CR a flat panel display, etc.). The UCM software is adapted to generate a signal which is then transmitted to the device with which it is connected (i.e., associated). This signal may result, for example, in a logon screen allowing for messages to be presented to a user. An interface to video switcher hardware may be used to provide this functionality.

When the UCM software detects that the automatic timeout limit has been reached, the UCM software ensures that any video signal coming from the device it is associated with (i.e., protecting from non-secure or unauthorised use) is no longer displayed on the screen of the associated device.

The UCM software is adapted to control the Switcher Control Module 210 such that each power receptacle at a node can be individually controlled (power on or off) and data streams can either be allowed to be passed to or from the other I/O devices of the node.

The UCM software includes a configuration program that is used to set the on/off status of each receptacle. The default for each receptacle is on. On power up, the UCM software sets the Switcher Control Module 210 to the last saved configuration. The UCM software is also capable of controlling all outputs from the Switcher Card 500 individually. This capability is required to support authorisation and role-based access.

6.2.7 Fail-Safe Operation

In the clinical environment, the most important aspects of the apparatuses employed are:

Safety of the patients (and caregivers)

Unimpeded clinical activities

Integrity of PHI

Therefore, should failure of an apparatus occur, regardless of whether this is through design error, hardware malfunction, accidental or deliberate misuse or some external factor, the delivery of patient services should not be impeded. Furthermore, information already acquired by the apparatus will not be lost or compromised.

In addition to this, an override mode will be provided. This is intended for use in emergencies where the normal operation of the system must be overridden to allow workstation access without proper user authentication. Selection of this operation will imnmediately trigger a system alarm and notify the system administrator. All DICOM operations will still be logged, however.

6.3 Support Modules

A number of modules are required or used to facilitate development, testing and demonstration of the HIPAAT Product. The following describes some embodiments of these modules.

6.3.1 User Directory

A simple user directory will be used to store the configuration and user information. Access to the directory will use the well known LDAP protocol, and one server will serve as the directory master.

6.3.2 Information Required from the Directory

ObjectClass = HIPAAT user
cn =<user name>
dn=<distinguished name>
IDCardNumber=<MD5 mag. card number digest>
PIN=<MD5 password/PIN digest>
PublicKey=<Public encryption key>
UserRole= Yes|1|No|0|<NULL>
AuditRole= Yes|1|No|0|<NULL>
DisclosureRole= Yes|1|No|0|<NULL>
LastName=<last name>
FirstName=<first name>
e-mail=<e-mail address of user>
telephone=<phone number>
pager=<pager number>
Runtime data:
Client=<worstationID>|<NULL>
LoginTime=<date/time>|<NULL>
Created=<date/time>
Updated=<date/time>
ValidUntil=<date/time>|<NULL> // <NULL> means invalid

The Security Repository 102 device stores all authentication information such that login information changed for a user becomes effective for all access control nodes 400. User set-up/maintenance may be done at the SR.

7. Summary

The invention described above covers at least some of the initial requirements for HIPAA security and auditing for an add-on solution to existing equipment:

1. Access control to equipment and the network is restricted to authorised users based on predefined roles.

2. Access to the equipment is captured and logged.

3. Access to PHI (DICOM events) is captured and logged.

4. Auditing of the logs is supported via web-based reports.

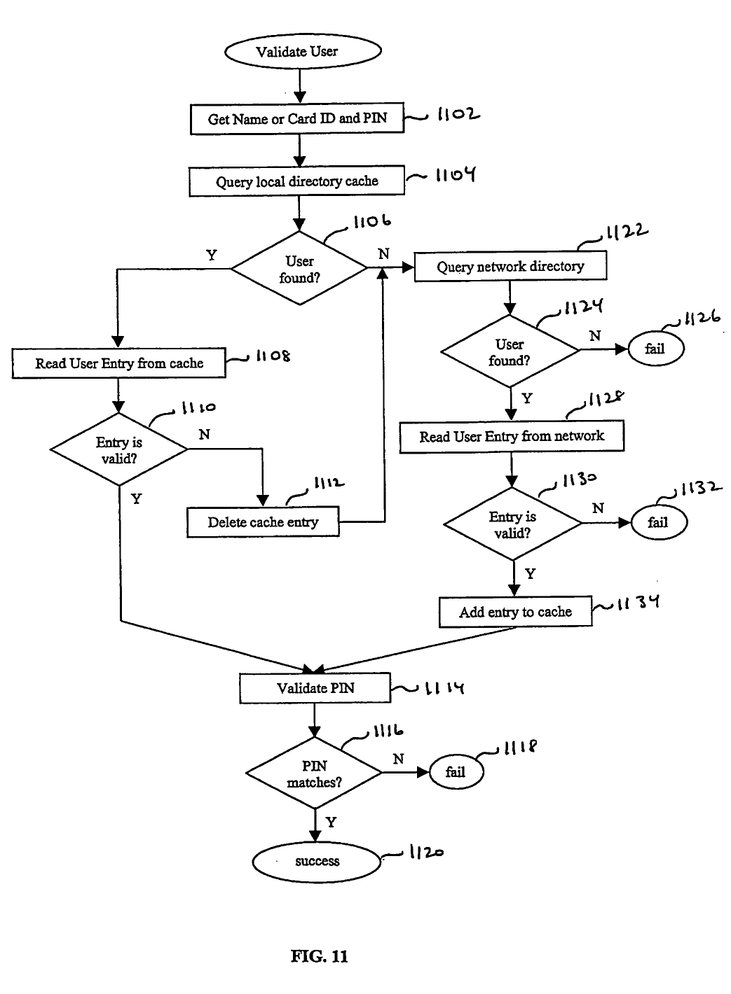

Referring to FIG. 11, a flow chart 1100 illustrating directory caching logic in accordance with an embodiment of the invention is illustrated.

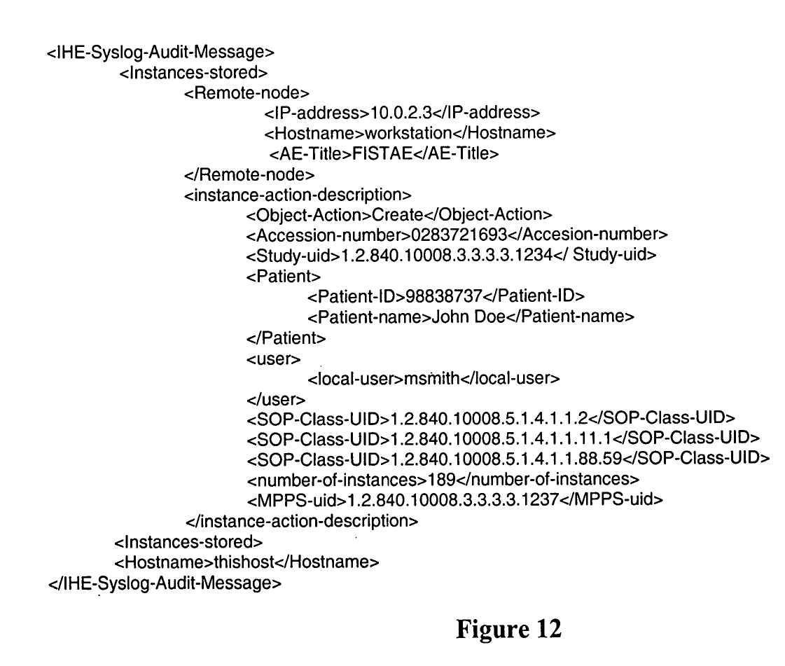

FIG. 12 illustrates an exemplary listing of a XML log event in accordance with an embodiment of the invention.

FIG. 4 is a block diagram illustrating an exemplary data processing system or access control node 400 in accordance with an embodiment of the invention. The access control node 400 includes an input device 410, a central processing unit or CPU 420, memory 430, a display 440, an output device 450, and a VGA switch 500. The input device 410 may include a keyboard, mouse, trackball, magnetic card proximity device, PIN input device, or similar device. The CPU 120 may include dedicated coprocessors and memory devices. The memory 430 may include RAM, ROM, databases, or disk devices, The display 440 may include a computer screen, terminal device, or television. And, the output device 450 may include a CD-ROM, a floppy disk, a printer, or a network connection. The VGA switch 500 is coupled to each of the CPU 420, an external console 460, and an external monitor 470. The external console 460 may be a medical imaging computer or system The external monitor 470 may be a computer screen or a medical imaging system display monitor. The access control node 400 has stored therein data representing sequences of instructions which when executed cause the method described herein to be performed. Of course, the access control node 400 may contain additional software and hardware a description of which is not necessary for understanding the invention.

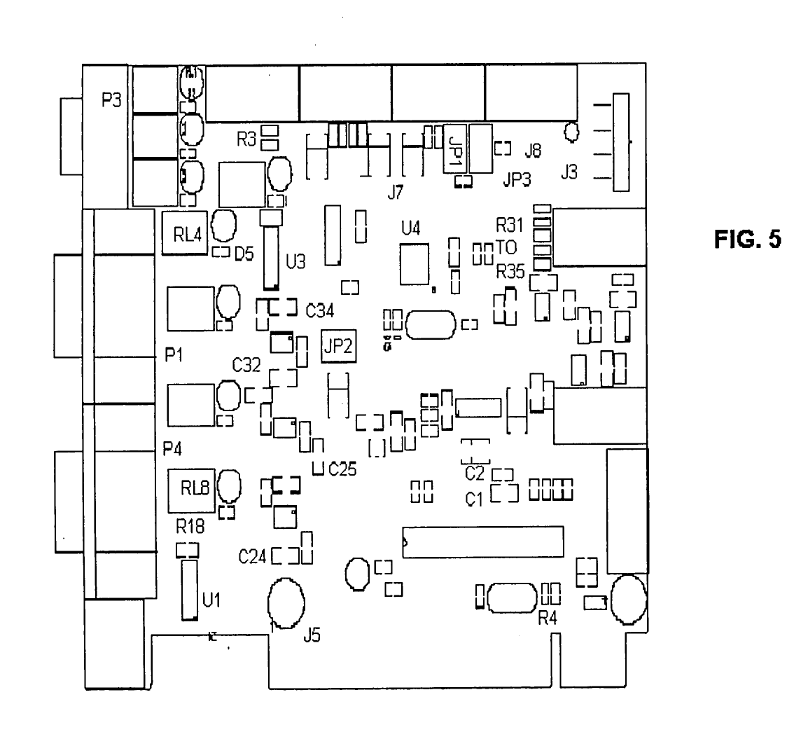

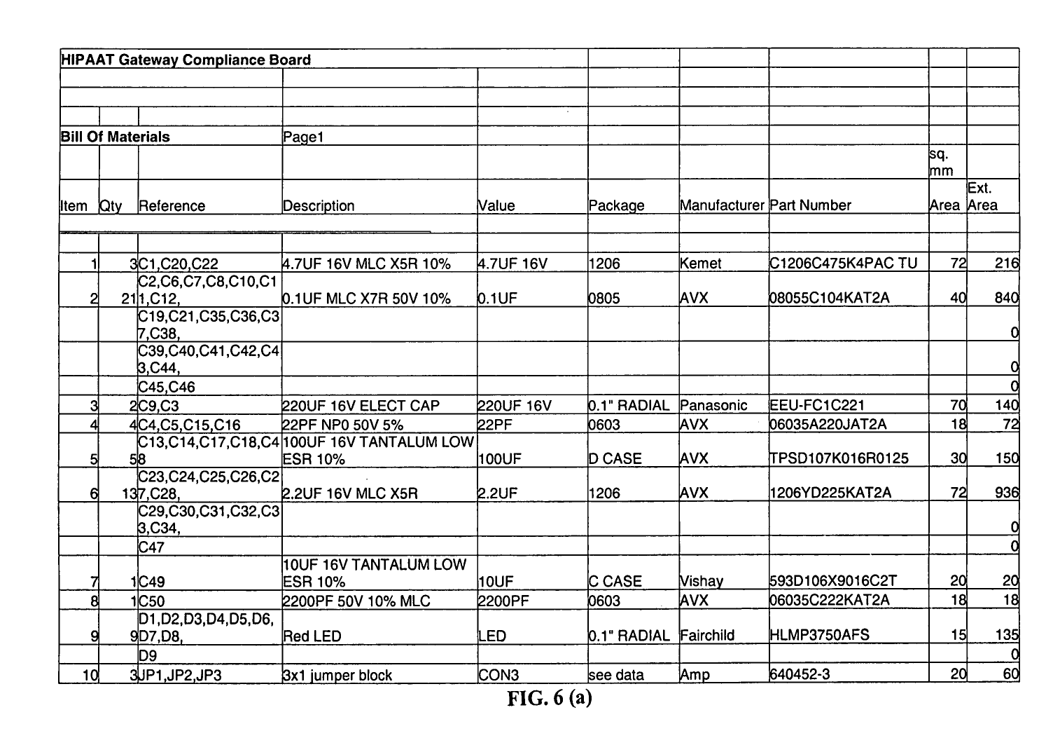

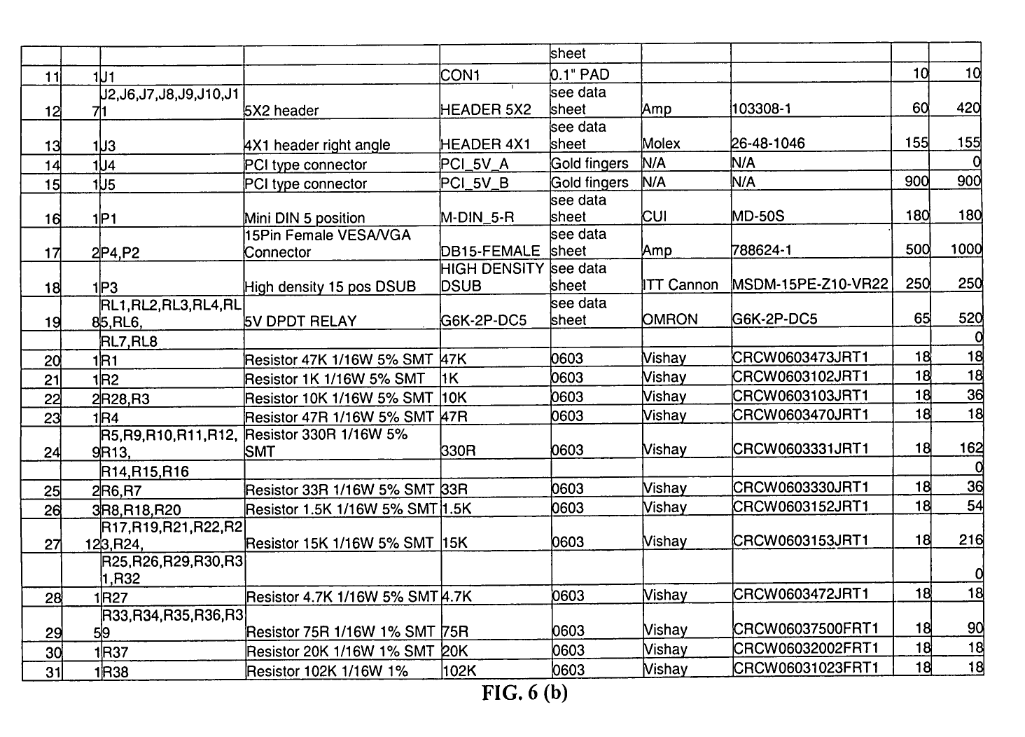

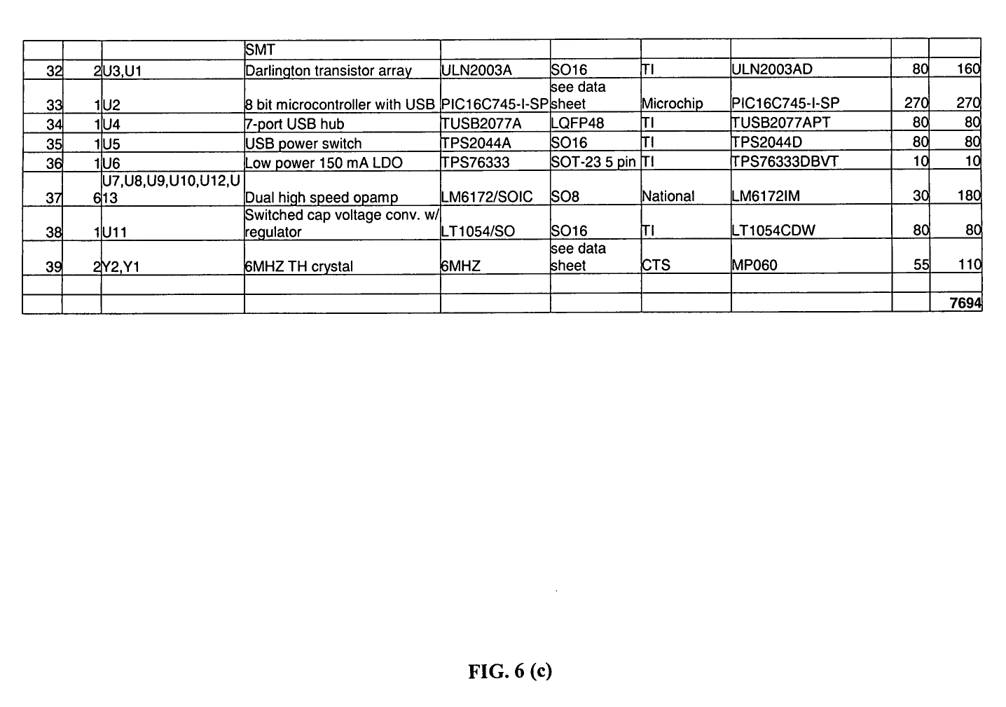

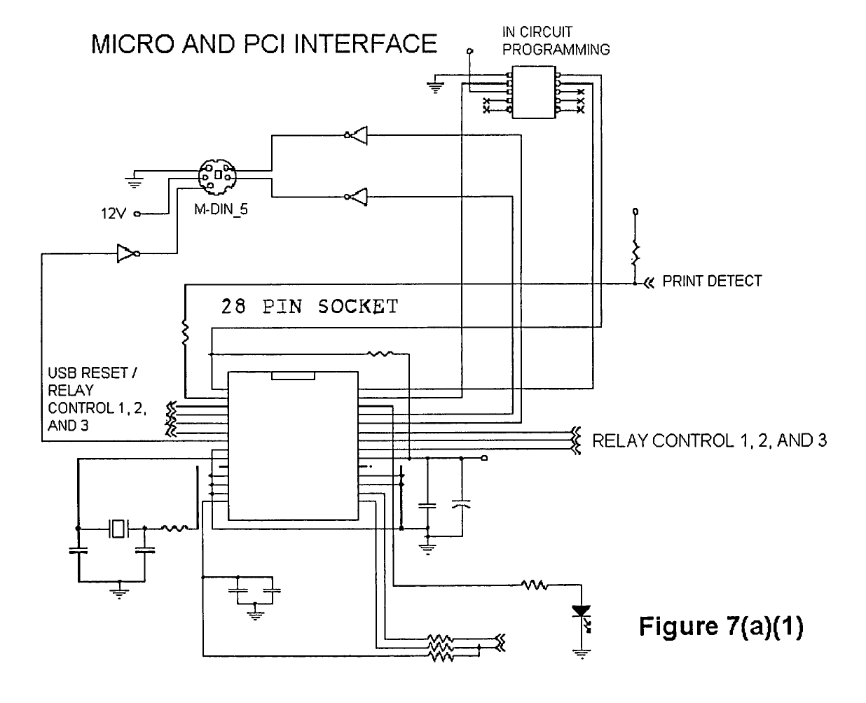

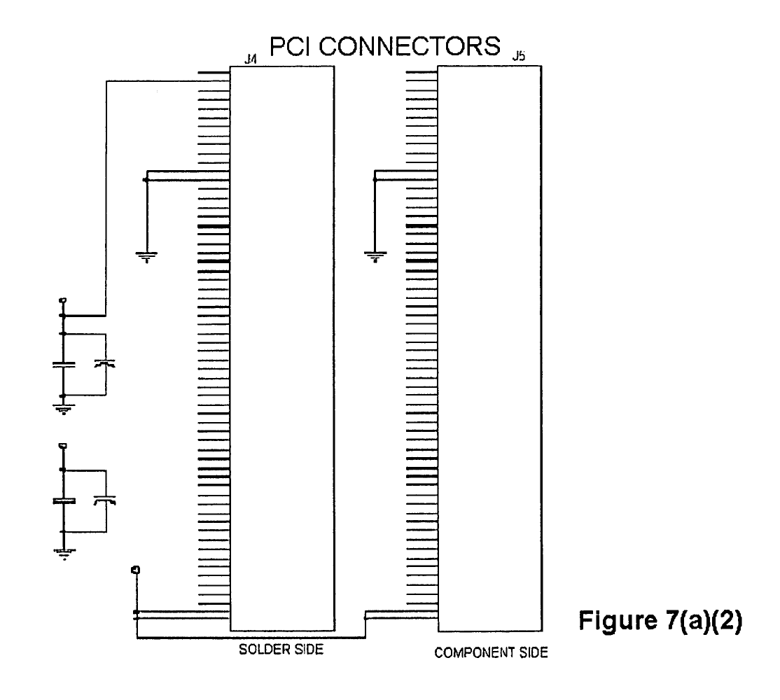

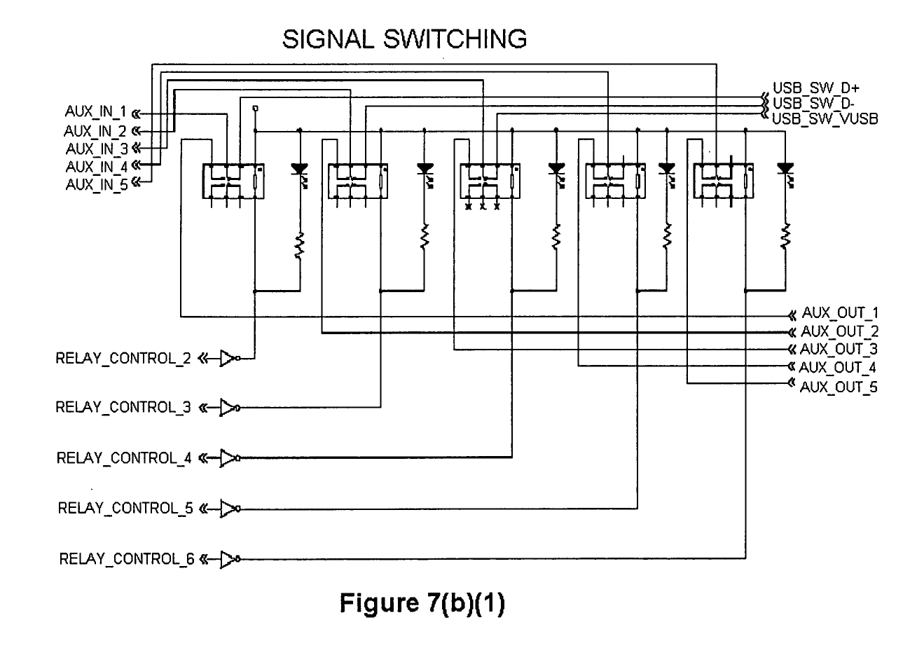

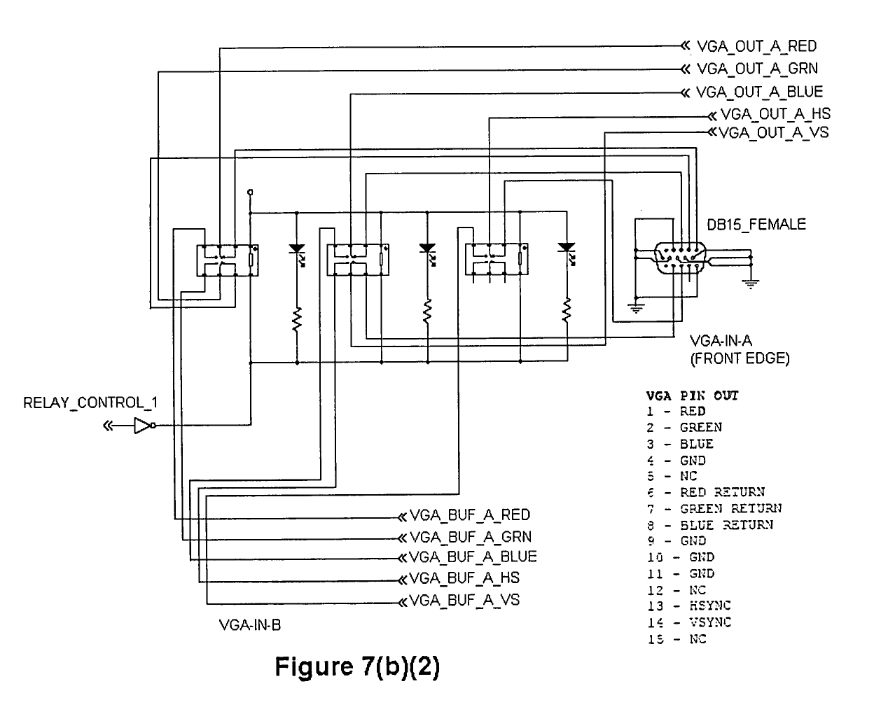

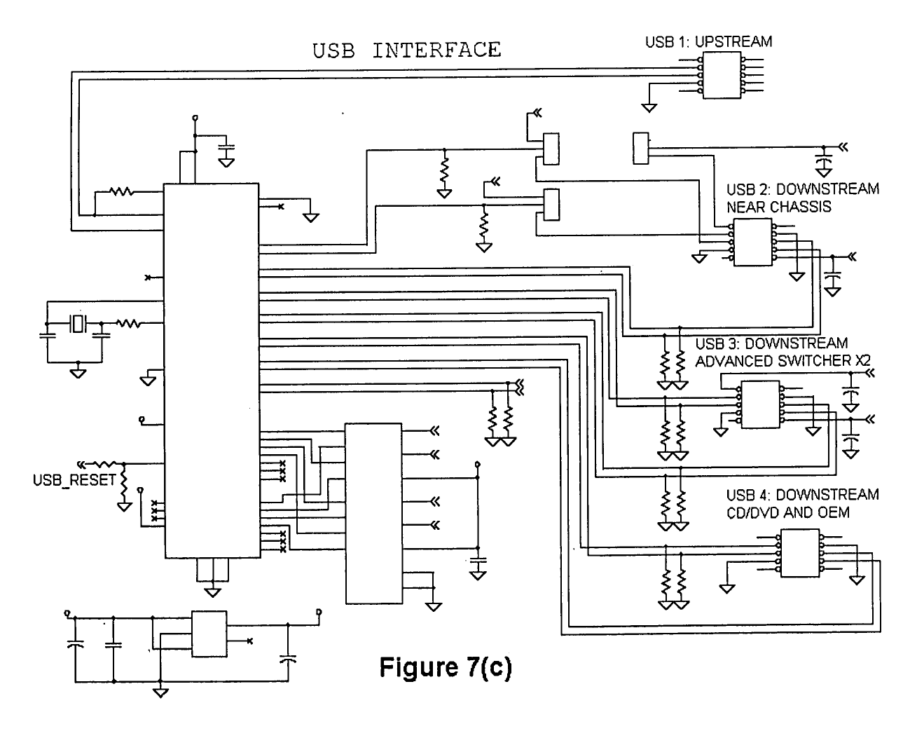

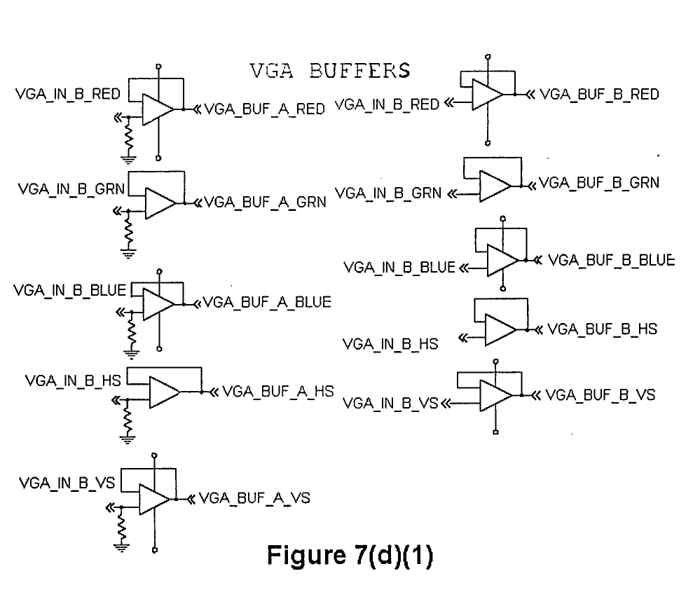

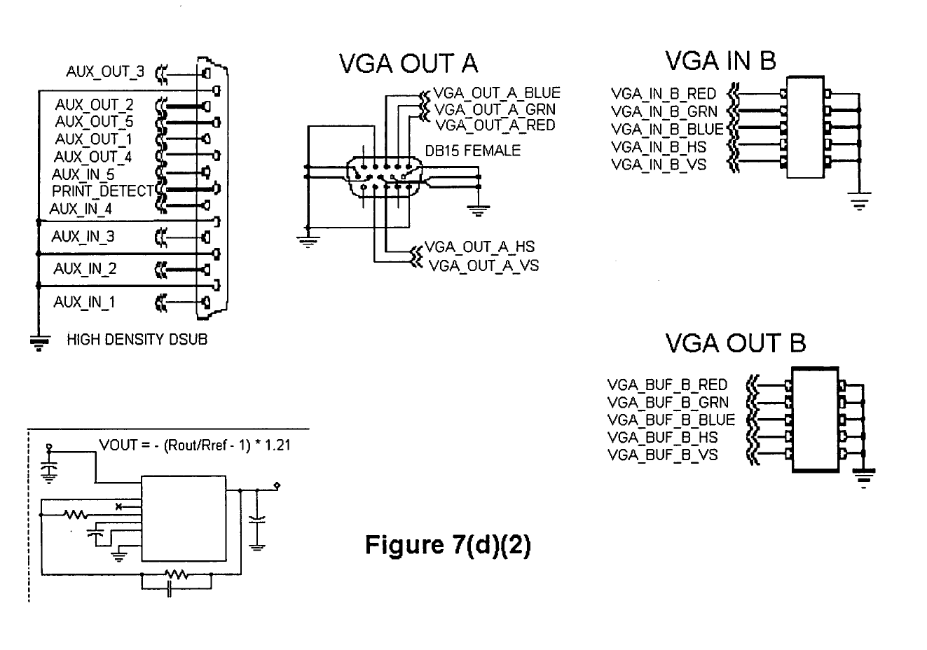

FIG. 5 is a printed circuit board layout diagram illustrating a VGA switch 500 in accordance with an embodiment of the invention. The VGA switch 500 may include a CPU, memory, relays, indicators, and connectors. FIG. 6 is an exemplary bill of materials for the VGA switch 500 of FIG. 5. And, FIG. 7 is a schematic diagram for the VGA switch 500 of FIG. 5.

Referring to FIGS. 47, in accordance with the method of the present invention described above, the VGA switch 500 is controlled by the access control node 400 to connect the external console 460 to the external monitor 470. When the VGA switch is closed, it allows VGA and/or other signals to pass from the external console 460 to the external monitor 470 for display to a user. When the VGA switch is open, a VGA logon message is generated by the access control node 400 and displayed on the external monitor 470 via the VGA switch 500. The open/close status of the VGA switch 500 may be controlled with a non-secure method by the access control node 400 or through a secure logon procedure controlled by the access control node 400. With the non-secure method, a user may control the status of the switch 500 by making a universal PIN# entry. In the secure mode, the access control node 400 may, for example, present a logon screen to the user via the external monitor 470 and/or display screen 440 and/or a PIN input device 410. To logon and close the switch, the user would have to enter a valid password or PIN as directed by the logon screen. Additionally or alternatively, a card access system could be used.

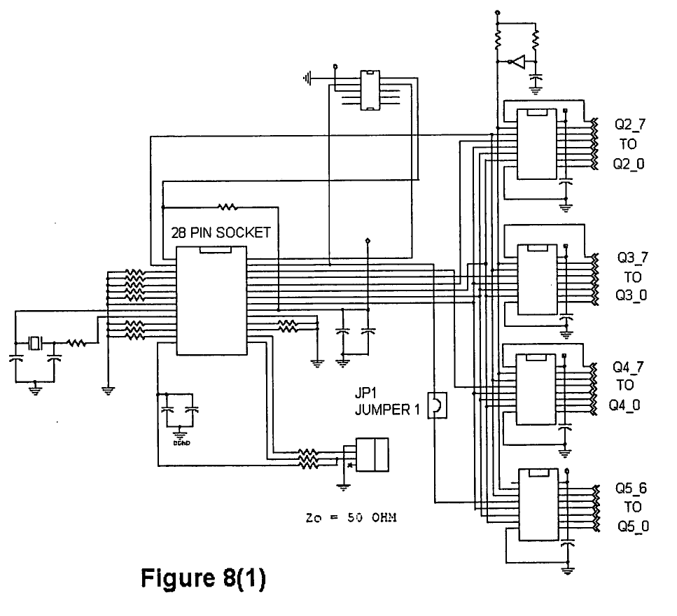

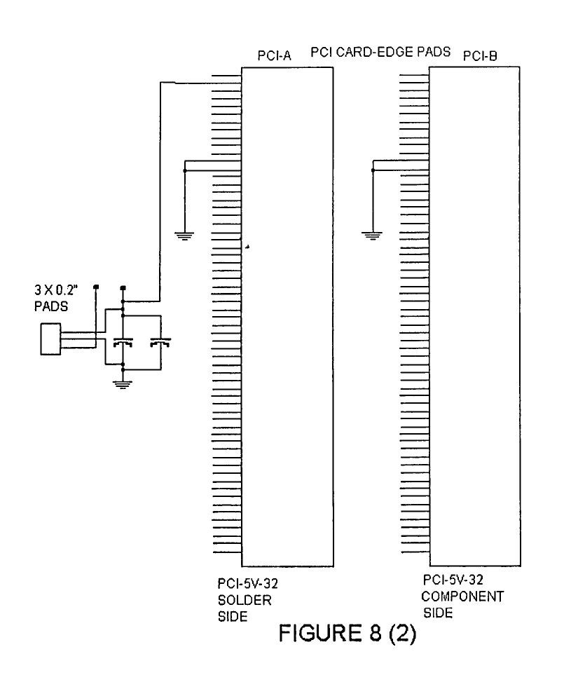

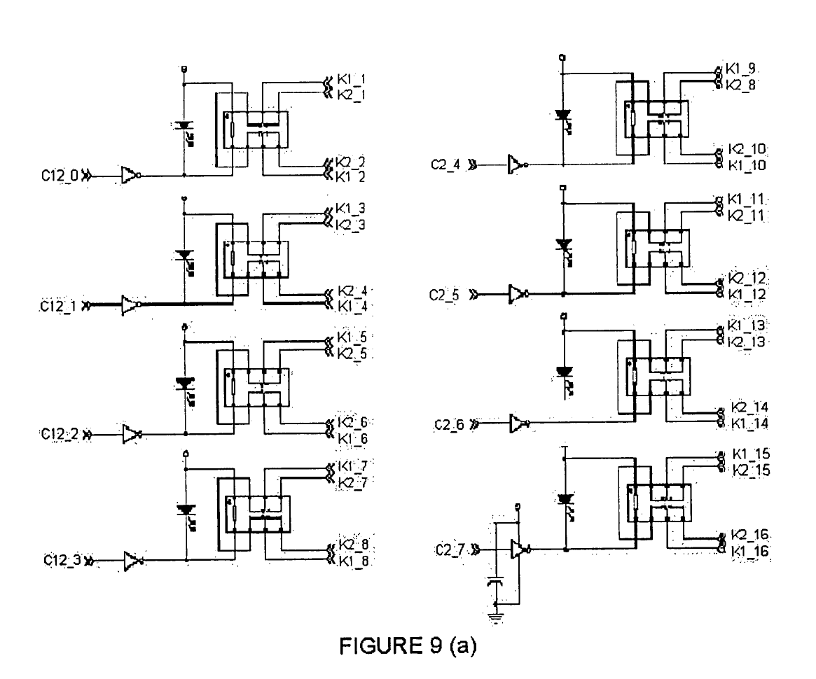

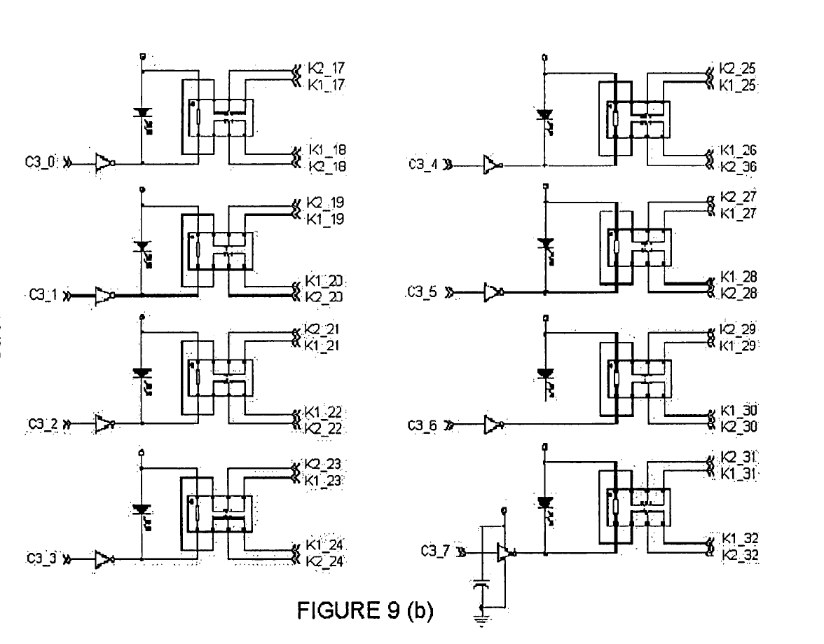

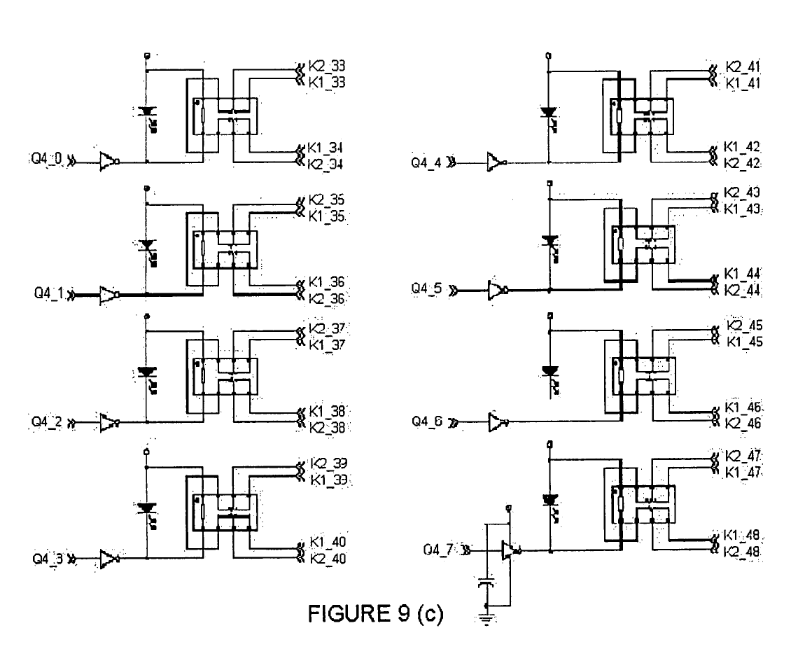

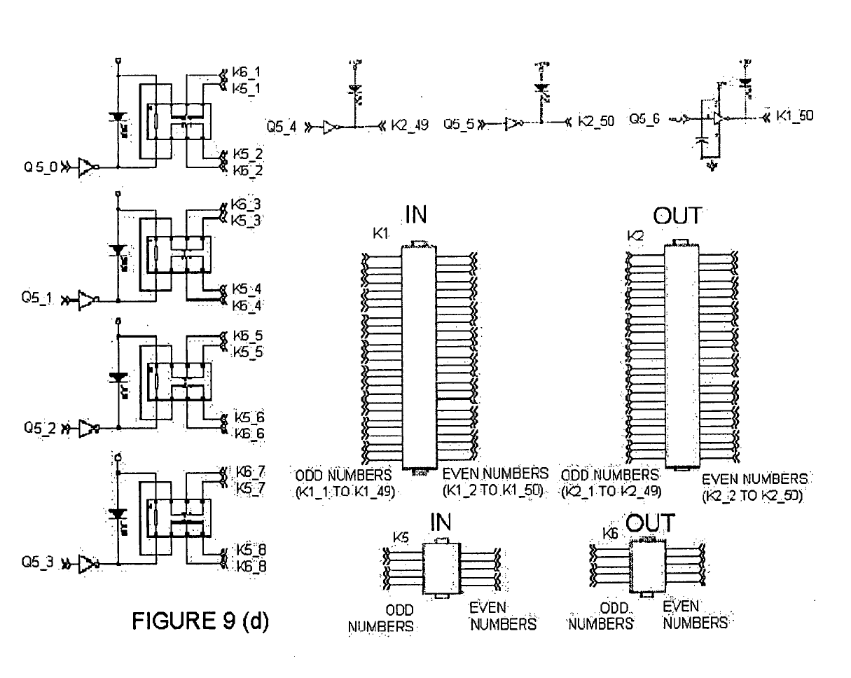

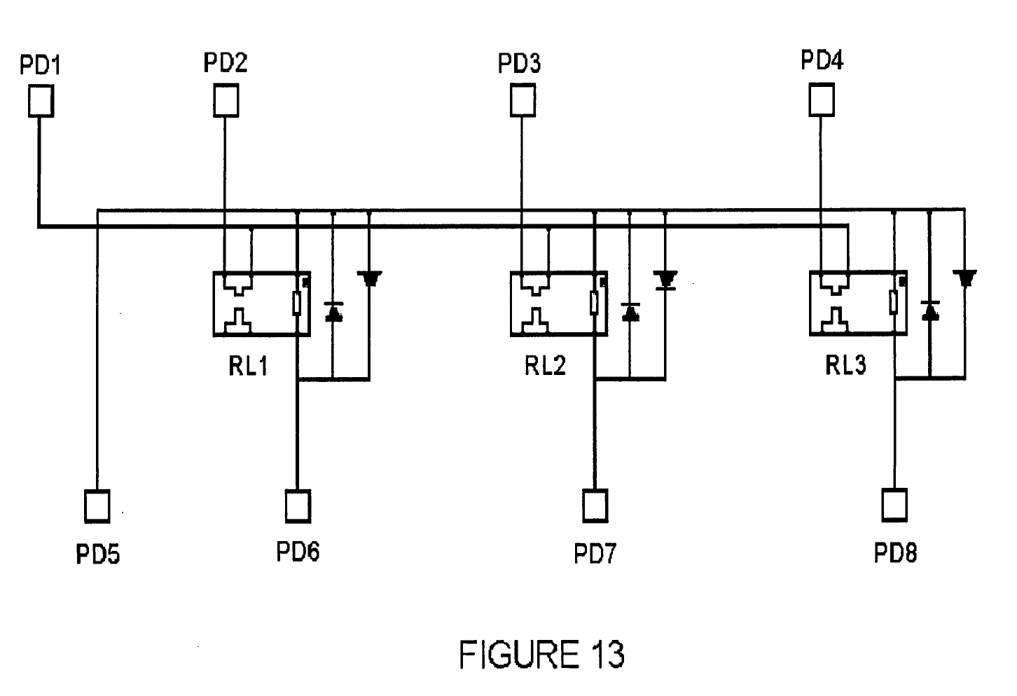

FIGS. 8, 9(a)-9(d), and 13 are wiring diagrams illustrating an alternate switch 500 in accordance with an alternative embodiment of the invention. The alternate switch may be used to switch multiple signals including I/O signals (e.g., video, audio, printer, or the like) and/or power supply lines to external devices, for example, a VCR or other removable media devices.

As mentioned above, the network gateway module monitors DICOM network messages, captures audit information, and relays this information to a Security Repository 102. These DICOM messages may be monitored, for example, as they pass from a first external console 470 to a second external console 470 through a switch 500 and/or as they pass through the network 212. The network gateway module 214 of the access control node 400 captures information (through operation of DICOM decoder 216) from DICOM messages, formats this information as XML documents, and sends the resultant XML documents to a repository 102 for subsequent processing and use by audit applications. The invention supports messages complying with additional and alternate standards including HL7.

As will be appreciated by those of ordinary skill in the art the present invention may be embodied in software or data instructions. This software, described above, may comprise more than one software module, that will, when executed by one or more access control nodes (e.g., a computer—whether personal or server, or other forms of computer processing devices), adapt the access control nodes to perform some or all of the functions described herein. For example, a UCM may be embodied in software that when loaded into and executed by a computer or computer server, adapts the computer or computer server to perform those functions described herein attributed to the UCM. As a further consequence of some or all of the functionality described herein being embodied in software, the software may be transported to users by way of a computer software product (e.g., a physical storage medium such as a diskette, CD, DVD, hard drive or the like). Similarly, given the nature of communications networks, this same software may be transported to a user electronically through transmission over one or more communications network rather than delivering a physical media to a user. Further, as will be appreciated by those of ordinary skill in the art, rather than embodying the invention in software or transporting/transmitting this software via a physical computer software product or over a communications network, aspects of the invention could also be embodied in an integrated circuit product including, for example, a coprocessor or memory according to an embodiment of the invention. This integrated circuit product can be installed in a computing device to perform the functionality of the access control node described above.

The interaction of a user with the various components described above and the interaction of those components with each other is best understood with reference to FIG. 2. To understand the interaction of these components an example will be used. The example consists of an operator attempting to gain access to some PHI from a node (e.g., an MRI Scanner) forming part of system 200.

Initially the operator desiring access To the node must access the access control node 400 (not shown) which includes a video display, keyboard (or keypad) and a card reader. Additionally, but likely unseen by the operator, access control node 400 includes a hardware switcher card and a mechanism for connecting to and communicating with the network and any centralised services. This mechanism, in most circumstances, is embodied in a communications network interface card such as an Ethernet card or a wireless network communications card. The video display is initially blank until the operator swipes or enters their magnetic card in or through the card reader. The access control node operates to read the card ID information stored on the card through control of the Card Authenticator Module. This will result in the access control node displaying a PIN entry screen (i.e., a logon screen) wherein the operator is prompted to enter, via the keyboard, their PIN.

Upon receipt of card ID, PIN and node ID data, the HIPAAT application will perform two primary operations: (1) user and node authentication; and (2) audit log creation.

The card ID, PIN data and node identification data is used by the HIPAAT application 202 to authenticate the user and node from which access is being sought by the operator. The HIPAAT application 202 will, through control of the user authenticator module, communicate with the user directory (which may be local or centralised). The authenticator module, using the authentication API, will determine whether the card ID is valid and, if so, whether the PIN data entered by the user conforms with the PIN data stored in the user directory associated with the card ID also stored therein. That is, if the card ID is valid (the card contains data for a valid account), the authenticator module determines whether the operator entered the correct PIN data. In the exemplary embodiment, the PIN data will be transmitted from the user directory (which may be local or centralised) to the HIPAAT application 202. This received PIN data is then compared against the PIN data entered by a the operator. If the PIN data entered was not correct or if the card ID was not associated with a valid account, the HIPAAT application 202 determines this state based on the received user PIN data. If the PIN data entered was correct, the HIPAAT application 202 also determines this state and, additionally, receives data indicative of the operator's permission to access data. This latter data is keyed or linked not only to the user but also to the node from which the operator has sought access. In the exemplary case, the data returned to the HIPAAT application 202 in response to an attempted user logon will indicate, for example, that the operator is entitled to view MRI scans but not print or store to a removable media. The HIPAAT application 202 is also provided with a userID that uniquely identifies the operator attempting to access PHI.

Based on the data received by the HIPAAT application 202 from the user authenticator module, control signals will be used to control the access control node 400. The access control node, responsive to the control by the HIPAAT application, will operate to either prompt the user for the correct PIN (assuming the card ID and node ID is valid), shutdown the associated node (if either the card ID or the node ID are not valid—e,g., the card has been terminated, the node is unrecognised, etc.) or selectively allow the operator to access some or all functionality provided by the node. In the exemplary case, the MRI scanner (which includes a display, a keyboard, a printer and a removable media drive—e.g., an external DVD-RAM or DVD-R drive) will only be partially powered allowing only partial access. The access control node provides this selective control by providing power to those portions of the MRI Scanner that the operator has been granted permission (e.g. the core of the unit enabling the viewing or creation of scans) but not its peripherals (i.e., the printer and the removable media drive are not provided with power). This selective powering of aspects of the node is provided through operation of the switcher control card which forms part of the access control node.

Regardless of whether access to PHI was granted to the operator as described above, the HIPAAT application 202 performs a second function, event logging. An attempted login (which was defined above as a “user authenticated” event) will result in the HIPAAT application 202 requesting storage of an event. The storage of event is initiated by the HIPAAT application 202 through access to the functionality of the Logging API Module 208 (described above). By passing data (e.g., the userID information previously received or the cardID information if the operator was not authenticated by the user authenticator module; the time and date; and the nodeID; etc.) to the logging API 208 an XML event (similar to the one illustrated in FIG. 12) is created and digitally signed by the HIPAAT application 202. This digitally signed event log (in XML format) is then entered in an event log queue. The events in the event log are then sent (individually or in batches) to the Security Repository server (SR server) 102. In an alternative embodiment, the SR server periodically inspects the event log for new events rather than having these events transmitted to the SR server automatically.

The (SR server) upon receipt of a new event log will store the event in the SQL database through access to the functionality of the Archive Module 104. The transmission of the event log to the SR server may employ any suitable communication protocol. However, in the preferred embodiment the HIPAAT application 202 and SR 102 communicate using secure HTTP (HTTPS) to ensure a level of security.

As will be appreciated by those of ordinary skill in the art, the user and node authentication and the event logging can be performed serially or, as in the embodiment described herein, in parallel.

Once user and node authentication has been completed, an operator may then attempt to perform various activities (i.e., events) in accessing, creating or deleting PHI. In the exemplary embodiment, the operator attempts to perform various events involving PHI through an MRI scanner which communicates with the domain using the DICOM protocol. Consequently, DICOM packets will be transmitted to and from the node as a result of the operator's input. In the preferred embodiment, packets transmitted from the node to the network are first intercepted by an UCM proxy 214. The UCM proxy 214 also intercepts DICOM packets destined for the node. The intercepted packets may be forwarded to their intended destination (e.g., another device on the network or the node) if the operator/user is entitled to make the request described by the packets (for packets transmitted from the node) or receive the information contained in the packets (for packets destined for the node). Whether the packets are forwarded to their intended destination will be determined by the functions performed cooperatively by the UCM Proxy 214, DICOM decoder 216 and the authentication library 204.

The packets intercepted by the UCM proxy 214 will include the node ID of the node that was the source or the destination of the packets. The UCM proxy will use this node ID for two purposes: (1) to record an event in the Security Repository 102; and (2) to determine whether to pass the packet onto the intended destination of the packet.

To generate the event for recording in the SR 102, the UCM Proxy 214 will pass a copy of an intercepted packet to the DICOM decoder 216 for processing. The DICOM decoder 216 will decode the received the copy of the intercepted packet and generate XML event describing the proposed activity. The SR 102, through a process similar to that described above, will then record this event

In determining whether to forward an intercepted packet the UCM proxy 214 will access the authentication library (using the node ID included in the intercepted packet) to determine whether the operator of the node has the permission to either transmit the request or alternatively receive the packet transmitted to the node. If the operator does not have the requisite permission, the UCM proxy will discard the intercepted packet. Otherwise the packet is forwarded to the intended destination.

As result of the co-operation of the DICOM proxy 214, DICOM decoder 216 and authentication library three effects result: (1) each activity will be recorded in the SR 102 (regardless of whether permission has been granted); (2) only those requests that an operator is permitted to make will be transmitted to the network (reducing network traffic); and (3) the node will only receive packets for which the operator is permitted to receive.

Persons of ordinary skill the art will appreciate that invention will provide other advantages. Moreover, various changes, alternations and modifications are possible without varying spirit and scope of the invention as defined by the claims herein. For example, aspects of the invention that are ascribed to the access control node could be performed by a centralised server. That is, aspects which are client-side based could be alternatively embodied on The server side. Similarly, aspects of the embodiment which are server-side based could be alternatively embodied on the client side. Other alternative embodiments of the present invention will be understood by the person of ordinary skill.

1. A method for providing access to data stored in a repository forming part of a network, said access being requested from a node also forming part of said network, said method comprising:
receiving at an access control node user identification, user password and node identification data, said access control node interposed between said node and said repository;
said access control node transmitting over said network said user identification, user password and node identification requesting authentication for said access request;
said access control node receiving control signals responsive to said authentication request; and
responsive to said received control signals, selectively providing access to a subset of the functionality provided by said node.

2. The method of claim 1 wherein said selectively providing access to a subset of the functionality provided by said node comprises:
selectively providing electrical power to portions of said node.

3. The method of claim 2 wherein selectively providing electrical power to portions of said node provides for control of peripheral devices forming part of said node.

4. The method of claim 1 wherein said selectively providing access to a subset of the functionality provided by said node comprises:
selectively providing I/O signals to said node.

5. The method of claim 4 wherein selectively providing I/O signals to said node comprises allowing some I/O signals to be transmitted to said node while denying transmission of other I/O signals to said node.

6. The method of claim 1 wherein said user identification comprises a user identification token.

7. The method of claim 6 wherein said user identification token comprises data collected from at least one of a magnetic card; a radio-frequency transmission or a biometrics scan.

8. A method for providing access to data stored in a repository forming part of a network, said access being requested from a node forming part of said network, said method comprising:
receiving user identification, user password and node identification data from an access control node associated with said node; and
transmitting control signals to said access control node, said control signals indicating limitations on the type of functionality to be provided to the user by said node, said user associated with said user identification and password.

9. The method of claim 8 further comprising:
generating said control signals, said control signals indicating:
if said user name and password data accurately correspond to an active user account, the type of access which is to be granted to said node; and
if said user name and password data do not accurately correspond to an active user account, a denial of access to said data in said repository.

10. The method of claim 9 wherein the type of access which is to be provided to said user comprise limitations on the data available for access by said user and limits on the use of said data available for access, said limitations determined in view of said received user identification, user password and node identification data

11. The method of 8 further comprising
intercepting messages transmitted to said node from other parts of said network; and
transmitting to a security repository a log event corresponding to each activity described by said intercepted messages.

12. The method of claim 11 wherein said transmitting to a security repository an event log comprises:
analysing said intercepted messages; and
generating said event log responsive to said analysis.

13. The method of claim 12 wherein said analysing comprises capturing audit information from said intercepted messages and said generating said log event comprises formatting said captured audit information into an audit log record.

14. The method of 13 wherein said intercepted messages conform with at least one of the DICOM and HL7 data formats and wherein said audit log record comprises data in the extensible mark-up language.

15. The method of 8 further comprising:
intercepting messages transmitted from said node to a repository forming part of said network; and
transmitting to a security repository a log event corresponding to each activity described by said intercepted messages.

16. The method of claim 15 wherein said transmitting to a security repository an event log comprises:
analysing said intercepted messages; and
generating said event log responsive to said analysis.

17. The method of claim 16 wherein said analysing comprises capturing audit information from said intercepted messages and said generating said log event comprises formatting said captured audit information into an audit log record.

18. The method of 17 wherein said intercepted messages conform with at least one of the DICOM and HL7 data formats and wherein said audit log record comprises data in the extensible mark-up language.

19. The method of claim 15 further comprising:
if said user name and password data accurately correspond to an active user account, identifying the data and repositories to which access is to be granted; and
if said user name and password data accurately correspond to an active user account, allowing only those intercepted messages to proceed to said repository if access to said data in said repository has been granted.

20. The method of claim 19 further comprising, prior to allowing only those intercepted messages to proceed, analysing the content of said messages.

21. The method of claim 9 wherein said control signals further indicate:
if said node identification data does not correspond to a recognised node, denial of access by said node to said repository.

22. The method of claim 8 further comprising:
transmitting to a security repository a log event corresponding to each activity described by said intercepted messages.

23. The method of claim 8 further comprising:
responsive for a request for log event data, retrieving from said security repository log event data satisfying said request.

24. The method of claim 8 further comprising:
providing a means for configuring said user identification and password data for new and existing users.

25. The method of claim 24 wherein said means for configuring comprises at least one of:
defining roles to which users will associated,
for each role defined, identifying the data for which access is to be granted and the type of functionality at a node that is to be made available to a user associated with a role; and
associating users with at least one of said defined roles.

26. A device for providing control of a node, said node forming part of a network, said device comprising:
an input for receiving user identification, user password and node identification data, said device interposed between said node and the remainder of said network;
an output adapted to transmit over said network said user identification, user password and node identification and data requesting authentication of the user identification, user password and node identification and, responsive thereto, receive control signals responsive to said authentication request; and
a switching device for selectively providing access to a subset of the functionality provided by said node.

27. The device of claim 26 wherein said selectively providing access to a subset of the functionality provided by said node comprises selectively providing electrical power to portions of said node.

28. The device of claim 27 wherein selectively providing electrical power to portions of said node provides for control of peripheral devices forming part of said node.

29. The device of claim 26 wherein said selectively providing access to a subset of the functionality provided by said node comprises:
selectively providing I/O signals to said node.

30. The device of claim 29 wherein selectively providing video signals to said node comprises allowing some I/O signals to be transmitted to said node while denying transmission of other I/O signals to said node.

31. The device of claim 26 wherein said user identification comprises a user identification token.

32. The device of claim 27 wherein said user identification token comprises data collected from at least one of: a magnetic card; a radio-frequency transmission or a biometrics scan.

33. A computer readable media storing data and instructions, said data and instructions when executed by a general purpose computer adapt said computer to provide access to data stored in a repository forming part of a network, said access being requested from a node forming part of said network, said data and instructions adapting said general purpose computer to:
receive user identification, user password and node identification data from an access control node associated with said node; and
transmit control signals to said access control node, said control signals indicating limitations on the type of functionality to be provided to the user by said node, said user associated with said user identification and password.

34. The computer readable media of claim 32, wherein said data and instructions further adapting said general purpose computer to:
generate said control signals, said control signals indicating:
if said user name and password data accurately correspond to an active user account, the type of access which is to be granted to said node; and
if said user name and password data do not accurately correspond to an active user account, a denial of access To said data in said repository.

35. The computer readable media of claim 34 wherein the type of access to said user comprise limitations on the data available for access by said user and limits on the use of said data available for access, said limitations determined in view of said received user identification, user password and node identification data.

36. The computer readable media of claim 33 said data and instructions further adapting said general purpose computer to:
intercept messages transmitted to said node from other parts of said network; and
transmit to a security repository a log event corresponding to each activity described by said intercepted messages.

37. The computer readable media of claim 36 wherein said adaptation to transmit to a security repository an event log comprises adaptations to:
analyse said intercepted messages; and
generate said event log responsive to said analysis.

38. The computer readable media of claim 37 wherein said adaptation to analyse comprises capturing audit information from said intercepted messages and said adaptation to generate said log event comprises formatting said captured audit information into an audit log record.

39. The computer readable media of claim 33 said data and instructions firer adapting said general purpose computer to:
intercept messages transmitted from said node to a repository forming part of said network; and
transmit to a security repository a log event corresponding to each activity described by said intercepted messages.

40. The computer readable media of claim 39 wherein said adaptation to transmit to a security repository an event log comprises an adaptation to:
analyse said intercepted messages, and
generate said event log responsive to said analysis.

41. The computer readable media of claim 40 wherein said adaptation to analyse comprises an adaptation to capture audit information from said intercepted messages and said adaptation to generate said log event comprises an adaptation to format said captured audit information into an audit log record.

42. The computer readable media of 41 wherein said intercepted messages conform with at least one of the DICOM and HL7 data formats and wherein said audit log record comprises data in the extensible mark-up language.

43. The computer readable media of claim 39 said data and instructions further adapting said general purpose computer to:
if said user name and password data accurately correspond to an active user account, identify the data and repositories to which access is to be granted; and
if said user name and password data accurately correspond to an active user account, allowing only those intercepted messages to proceed to said repository if access to said data in said repository has been granted.

44. The computer readable media of claim 43 said data and instructions further adapting said general purpose computer to, prior to allowing only those intercepted messages to proceed, analyse the content of said messages.

45. The computer readable media of claim 34 wherein said control signals further indicate:
if said node identification data does not correspond to a recognised node, denial of access by said node to said repository.

46. The computer readable media of claim 32 said data and instructions further adapting said general purpose computer to:
transmit to a security repository a log event corresponding to each activity described by said intercepted messages.

47. The computer readable media of claim 32 said data and instructions further adapting said general purpose computer to:
responsive for a request for log event data, retrieve from said security repository log event data satisfying said request.

48. The computer readable media of claim 32 said data and instructions further adapting said general purpose computer to:
provide a means for configuring said user identification and password data for new and existing users.

49. The computer readable media of claim 48 wherein said means for configuring comprises at least one of:
defining roles to which users will associated;
for each role defined, identifying the data for which access is to be granted and the type of functionality at a node that is to be made available to a user associated with a role; and
associating users with at least one of said defined roles.

50. A method for generating audit logs for a network, said network comprising a plurality of nodes interconnected by way of a communications network, said method comprising:
upon initial access by any user of a plurality of users, generating a login event record from user identification and password data received from an access control point from a plurality access control points, each of said plurality of access control points associated with one of said plurality of nodes;
intercepting all messages transmitted to or from each of said plurality of nodes; and
storing an audit log event in a repository for each activity identified in said intercepted messages.

51. The method of claim 50 further comprising:
analysing said intercepted messages so as to determine the activities represented by said intercepted messages.

52. The method of claim S1 wherein said analysing comprises:
identifying the format of the intercepted messages;
for each format identified, passing a subset of intercepted messages conforming to the format identified to a decoder for processing that format;
each decoder capturing activity and audit information from said subset of intercepted messages passed.

53. The method of claim 52 wherein the format of the intercepted messages conforms to at least one of: the DICOM and HL7 data formats.

54. The method of claim 51 further comprising: prior to said storing, generating said audit log event for each identified activity in said intercepted messages.

55. The method of claim 54 wherein said generating comprises:
creating said audit log event for each identified activity in said intercepted messages from data captured during said analysing.

56. The method of claim 55 wherein said audit log events conform to the extensible mark-up language (XML).

57. The method of claim 51 wherein each audit log event comprises a digital signature.

58. A method for providing access to data for a plurality of users, said to data stored on a network, said network comprising a plurality of nodes, each of said plurality nodes associated with an access control node, each of said access control nodes interposed between its associated node and the network, said method comprising:
defining a plurality of roles to which users will associated;
for each role defined, identifying the data for which access is to be granted and the type of functionality at each of said plurality of nodes that is to be made available to a user associated with a role; and
associating each of said plurality of users with at least one of said defined roles.

59. The method of claim 58 further comprising:
for each attempted access to said data by a user at node, receiving user identification, password and node identification data;
if said user identification and password correspond to an active user account, generating a control signal indicating any limitations on the functionality of the node from which access has been attempted;
transmitting said control signal to the access control node associated with the node from which access has been attempted.

60. The method of claim 59 wherein said limitations on the functionality of the node are determined based on the capability of the node and the one or more roles which are associated with said active user account.

61. The method of claim 60 wherein said the capability of the node is determined by reference to repository of the capabilities of each of said plurality of nodes in the network in view of the node identification data received.
